(19) United States
(12) Patent Application Publication
(10) Pub. No.: US 2016/0232536 A1
(43) Pub. Date: Aug. 11, 2016

(54) AUDITING, COMPLIANCE, MONITORING, AND COMPLIANCE MANAGEMENT

(71) Applicant: NextLOGik, Columbia, MD (US)

(72) Inventors: Kirk COUSER, Columbia, MD (US); Jarred CAPELLMAN, Columbia, MD (US)

(21) Appl. No.: 15/131,926

(22) Filed: Apr. 18, 2016

Related U.S. Application Data
(63) Continuation-in-part of application No. 14/012,935, filed on Aug. 28, 2013.
(60) Provisional application No. 61/694,053, filed on Aug. 28, 2012.

(51) Int. Cl. G06Q 30/00

(52) U.S. Cl. CPC G06Q 30/018

(57) ABSTRACT

Compliance auditing and management is provided by defining business or enterprise assets, comprising receiving, from the business or enterprise variables that meet business needs of the business or enterprise as a user. Users, locations and audit templates are added. Questions to be provided to the user are entered and compliance criteria used in answering the questions and associating the compliance criteria with the questions are added. Compliance activity information from the user is received and the compliance activity information from the user to the questions is applied. Compliance activity for the user to generate a database of deployed compliance activities is scheduled and the database of deployed compliance activities is used to conduct compliance activity. The database of deployed compliance activities or the conducted compliance activity is used to generate files and incidents. The database of deployed compliance activities is used to generate compliance activity reporting.

### RELATED APPLICATION(S)

The present patent application is a Continuation-in-Part of U.S. patent application Ser. No. 14/012,935, filed Aug. 28, 2013 and claims benefit of Provisional Patent Application No. 61/694,053 filed Aug. 28, 2012, which are filed by the inventor Kirk Couser, and which is incorporated by reference herein.

### BACKGROUND

1. Field

The present disclosure relates to audit and compliance techniques and software.

2. Background

Compliance audits are required for regulated procedures such as, by way of non-limiting example, medical laboratories used for performing medical tests.

A typical compliance process is often heavily paper-based, and involves collection of documents, creating lag time in entering data, greater opportunities for inaccuracies and errors. Inefficiencies exist because the lag time in reporting can affect managerial decisions, time spent on site for audit/surveys can be inefficient, and communication can be fractured amongst levels of management and employees.

There has been a significant increase in the need for compliance and oversight across a broad range of industries, many of which did not have any of those requirements placed upon them before. The need to develop a data-driven, real time compliance process is higher than ever. Currently, there are few compliance management programs or techniques that allow for quick deployment and simple customization and yet still provide real time.

### SUMMARY

Compliance auditing and management according to compliance criteria and the use of at least one sensor. A set of compliance criteria is provided, and a sensor capable of monitoring at least one condition for compliance and capable of communicating with a mobile networked communication device is provided. The sensor is paired with the mobile networked communication device using a short range wireless communication link. Data from the sensor is provided to the networked communication device in a format compatible with an operating system of the mobile networked communication device, using filename conventions and other data characteristics are in a format compatible with network communication. Data, comprising the monitored condition, is transmitted from the sensor to a monitoring server, such that the transmitted data comprising the monitored condition. The monitoring server can derive a time profile of the monitored condition. At least one condition identified by the compliance criteria, and the process is monitored over time and monitored as a time-condition series.

### BRIEF DESCRIPTION OF THE DRAWINGS

FIGS. 1A 1E are diagrams showing data collection using sensors and mobile devices. FIG. 1A shows sensor hardware paired with mobile device. FIG. 1B shows establishing a probe connection. FIG. 1C shows reading of temperature. FIG. 1D shows temperature data sent to a mobile device. FIG. 1E shows the integration of the temperature data into an automated auditing process.

FIG. 2 is a flow diagram showing the operation of a compliance monitoring program.

FIG. 3 is a diagram showing the relationship between the compliance criteria and questions asked of the user.

FIG. 4 is a diagram showing the relationship between the questions asked of the user with comments and scoring.

FIG. 5 is a diagram showing the use of the generated files, comments or incident reports and deployed compliance activities.

FIG. 6 is a diagram showing the implementation of audit conducting and reporting tools.

FIGS. 7A-7R are diagrams depicting deployment of the program for implementation in performing audits.

FIG. 8 is a logon screen showing a logon for access for compliance monitoring.

FIG. 9 is a diagram showing connections to the logon for access for compliance monitoring of FIG. 8.

FIGS. 10A-10G are screen images showing the use of compliance monitoring. FIGS. 10A-10F depict an enterprise audit report. FIG. 10G depicts a local audit report used for immediate compliance reinforcement.

FIGS. 11A-11K are screen images showing screenshots of compliance management tools. FIG. 11A shows a document management tool. FIGS. 11B-11D show an administrative manager “locations manager” function. FIG. 11E shows a screen for adding a user. FIG. 11F shows a screen for adding a role for the user. FIG. 11 G shows criteria displayed for the compliance management. FIGS. 11H-11K show a list of questions used for compliance management. FIG. 11I shows a window for adding a question. FIG. 11J shows a screen for adjustment and display of audit scoring. FIG. 11K shows a screen for editing a question.

FIGS. 12A-12K are screen images showing screenshots of audit management tools, which are a part of the compliance management. FIGS. 12A and 12B show an audit list and the creation of a new audit. FIGS. 12C and 12D show screens for adding audit sections and audit questions. FIG. 12E shows a screen for conducting a quick audit. FIG. 12F is a screen for the user to take a self-assessment. FIG. 12G is a screen showing an individual audit question. FIGS. 12H and 12I are audit scheduling screens. FIGS. 12J and 12K are help screens.

FIGS. 13A-13N are depictions of user interfaces using a first type of smartphone.

FIG. 14 is a depiction of a user interface using a computer tablet.

FIGS. 15A-15I are depictions of user interfaces using a second type of smartphone.

FIGS. 16A-16F are depictions of web-based interfaces for monitoring multiple certifications.

FIG. 17 is a schematic diagram showing an overview of the compliance monitoring system.

### DETAILED DESCRIPTION

### Overview

The disclosed technology, referred to as “CompWalk”, is a comprehensive auditing, compliance, monitoring, and (on demand) facility auditing and compliance management system. It is designed to be accessible and user-friendly, a highly accessible compliance software program. The present subject matter utilizes easy to configure and web-based and mobile application tools; multiple feature modules allow for integrated communication in real time; create and manage multiple audit/survey deployments; real time executive dashboard reporting and the ability to create ad hoc reports.

The disclosed technology implements an audit and compliance walkthrough management system that delivers mobile-friendly, web-based software tools and applications to connect management and personnel in the field with unparalleled ease. With the disclosed technology's on-demand auditing and compliance workflow, a user can customize user permissions, survey content and reporting—system-wide—in a few simple clicks. Since the disclosed technology implements delivery through the Software as a Service (SaaS) model, (it works via the Internet), organizations can access the power of a much larger compliance system while maximizing cost-efficiencies by avoiding the expense of software upgrades, support and training typically associated with legacy systems (that can require complex installation procedures).

Data collection and reporting is a common issue for small to large organizations. While it can be time-consuming, it is also necessary to be thorough when assessing people, places, or things for quality and safety. The disclosed technology reduces lag-time in data collection and reporting by automating tasks involving human intervention, like sending an email or entering in a data point. These manual tasks can lead to human error, whether it is forgetting to complete a task or entering incorrect information. By collecting information on mobile devices in real-time and compiling the reports automatically, the disclosed technology vastly reduces the potential for human error.

The use of automatic monitoring in the “CompWalk” comprehensive auditing, compliance, monitoring, and on-demand facility auditing and compliance management system provides an essentially full-time compliance monitoring system. The combination utilizes enterprise mobile device attachments to mitigate lag-time and human error in data collection processes for quality and compliance. The comprehensive auditing, compliance, monitoring, and on-demand facility auditing and compliance management system can be implemented as a cloud-based, online and mobile networked application that automates compliance, inspections, and certification operations. The system reduces the time it takes to complete assessments and issue reports while storing and managing all documentation in a singular repository. By automating many manual, time-consuming tasks in the data collection process, the disclosed technology allows organizations to conduct assessments efficiently, saving them time and resources.

Data collection and reporting is a common issue for small to large organizations. While it can be time-consuming, it is also necessary to be thorough when assessing people, places, or things for quality and safety. The comprehensive auditing, compliance, monitoring, and on-demand facility auditing and compliance management system reduces lag-time in data collection and reporting by automating tasks involving human intervention, such as sending an email or entering in a data point. These manual tasks can lead to human error, such as forgetting to complete a task or entering incorrect information. By collecting information on mobile devices in real-time and compiling the reports automatically, the system reduces the potential for human error. Many organizations are investing in mobile strategies and encouraging “bring your own device” policies due to the sheer convenience and availability of mobile enterprise software and cloud storage. With this shift in mobility comes new hardware attachments for these devices aiding in business operations, especially data collection. Such devices comprise thermal imaging cameras, air quality monitors, GPS trackers, and temperature sensors that can attach to a phone, survey the area and produce quality data within their application. This information is verified by a trusted source and can be recorded within an audit or inspection. The ability to collect verified data from a slew of hardware attachments for quality and compliance measures saves organizations time and reduces the risk of human error.

Hardware monitoring devices generally use their own applications to record information. Therefore, the person conducting the audit must then transcribe the data, which can lead to the aforementioned reliability problems, such as lag-time and human error. The comprehensive auditing, compliance, monitoring, and on-demand facility auditing and compliance management system is able to capture this data as meta-data, and automatically populate it within the audit or inspection in real-time, without the need for human intervention.

By way of non-limiting example, if a field engineer is conducting a safety inspection of a county building and needs to record the exact temperature space heaters are emitting in personal offices, the engineer can do so using the disclosed technology. By way of further non-limiting example, the engineer can connect a thermal imaging camera to an iPhone, and the engineer could point it at each space heater and take a picture that records the temperature. This picture is then automatically uploaded into his inspection including the verified temperature reading without requiring the engineer to enter any data manually. The ability to collect verified data from a slew of hardware attachments for quality and compliance measures saves organizations time and reduces the risk of human error.

Data Collection Processes for Quality and Compliance

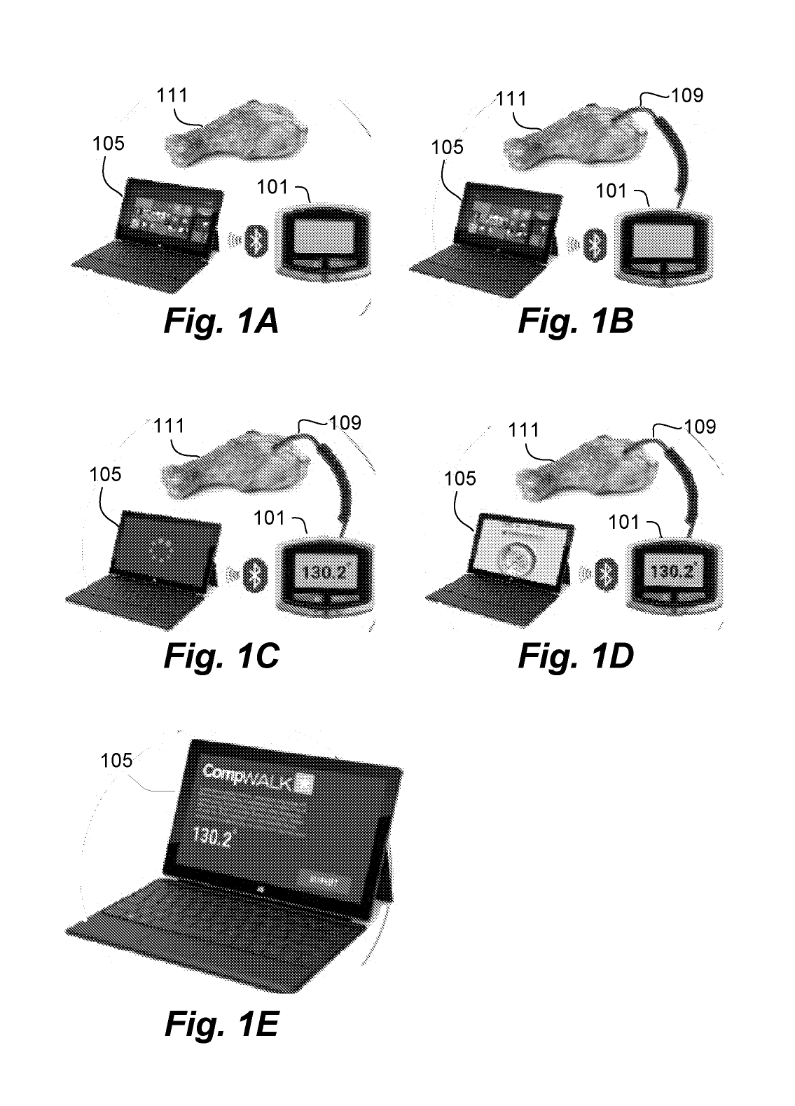

FIGS. 1A-1E are diagrams showing data collection using sensors and mobile devices. In the depicted example, food cooking and post-preparation temperatures are monitored.

The food preparation temperature is given as a non-limiting example, because many variables affect food preparation temperature and its effects. The initial food preparation should be sufficient to kill most bacteria, but it is not essential that all bacteria be killed if the food is to be consumed immediately. Post-preparation temperature and time is important in that bacteria and other spoilage is affected by temperature over time. This is particularly significant in cases in which food is not thoroughly cooked and is then left at a temperature slightly elevated at room temperature. On the other hand, food kept at elevated temperature may over-cook, which reduces palatability. The time-temperature profile is also affected by the original conditions, so, for example, if the food is thoroughly cooked, there is less initial bacterial contamination and the post-preparation shelf life can be considerably longer.

In the case of food, as with other items which must be monitored, it is possible to monitor one sample within a lot of similar items. Thus, in the depicted example, a single food item may be used to monitor the time-temperature profile of a large number of similar items that are prepared at the same time.

Similar issues can occur in different fields, for example in the handling of laboratory specimens, time-temperature measurements are critical even though the initial taking of the specimen is under substantially uniform conditions. Other non-limiting examples include humidity in a room or temperature of a device.

In FIGS. 1A-1D, sensor hardware 101 is paired with a mobile device 105 by short range wireless connection, such as a Bluetooth Low Energy communication link. (Bluetooth is a registered trademark of Bluetooth Special Interest Group of Kirkland, Wash.) Bluetooth is given as a non-limiting example, and the short range wireless communication can be performed by any convenient means, such as radio, infrared and wired connection. The data is supplied to the mobile device in a format compatible with the mobile device's operating system, which, by way of non-limiting example, could be a Windows OS. The data format preferably is suitable for network communications, so filename conventions and other characteristics are maintained in a format compatible with anticipated network communication.

Temperature is given by way of non-limiting example, and it is possible to monitor any of a variety of conditions, including, also by way of non-limiting examples, power, operating stress, biological conditions, power consumption, load factors and speed.

As depicted in FIG. 1A, sensor hardware 101 is paired with mobile device 105 using a Bluetooth Low Energy communication link. As depicted in FIG. 1B, a probe connection 109 is made, so that sensor hardware 101 is able to monitor sample food item 111. As depicted in FIG. 1C, temperature is read and may be displayed by sensor hardware 101, provided that sensor hardware 101 has a readaout display function. The sequence depicted by FIGS. 1A-1C can be changed, since the end result is the ability to read sensed information from the sample (in this example temperature) and communicate the sensed information to mobile device 105.

As depicted in FIG. 1D, temperature data sensed by sensor hardware 101 is sent to mobile device 105 by Bluetooth. As depicted in FIG. 1E, the temperature data is integrated into an automated auditing process. The automated monitoring process can be performed by mobile device 105 or at a remote location through a network. Communications between sensor hardware 101 and mobile device 105 can be identified by time stamp. This allows the automated monitoring process to be monitored over time and monitored as a time-temperature series. The time-temperature computations can also be provided at either the mobile device 105 level or at the network level, for example, by a network server (not shown in FIG. 1).

Real-Time, Enterprise-Friendly Audit Management and Data Collection

The compliance and monitoring system is scalable to meet each individual company's size and growth. The disclosed technology provides centralized access to compliance and audit information in real time making it an invaluable management tool for organizations looking to be more agile in today's ever changing marketplace.

Compliance Management with Less Paper and More Power

With the disclosed technology, organizations are able to automate manual audit processes and manage people, procedure and technology seamlessly. The disclosed technology's mobile flexibility makes paperless compliance inspections more efficient and simplifies field data collection during follow-ups to regulatory inspections and incident investigations. In addition, organizations can also leverage the disclosed technology's compliance management and communication framework as a vehicle for new and ongoing personnel training, new policy and procedure implementation:
Real-time data submission and reporting
Flexible scoring metrics
Web-based and mobile audit tools
Unlimited audit/survey creation
Conduct more audits, more accurately
Ability to use for training
More control over the entire process
More integrated communication within the organization
The development of the disclosed technology provides improvements in the laboratory accreditation arena and applies proprietary technologies, knowledge and experience to respond to market demands for a more streamlined approach to audit and compliance management programs across a wide range of industries.

Quality, Compliance and Audit Management Features

What separates the disclosed technology's audit and compliance software from other web-based audit software or techniques is its advanced, customizable, on-demand software implementation for all types of compliance needs. Since the disclosed technology implements delivery through the SaaS model, organizations can leverage the power of a much larger compliance system at a fraction of the cost and access regular upgrades, community-based support and training while avoiding the pitfalls and expense of legacy-based systems.

Flexibility, Mobility and More Capabilities any Compliance Program

What separates the disclosed technology's audit and compliance software from other web-based audit software and techniques is that it is an advanced, customizable, on-demand program for all types of compliance needs. Since the disclosed technology implements delivery through the SaaS model, organizations can leverage the power of a much larger compliance system at a fraction of the cost and access regular upgrades, community-based support and training while avoiding the pitfalls and expense of legacy-based systems.

The disclosed technology provides pre-defined users with the ability to dynamically create their own surveys, questions and scoring criteria, as well as to track versions of surveys and questions so that a full history is always available for reference. This degree of control and flexibility increases efficiency, quality and accuracy across the organization's audit program.

There are three ways through which users can connect with the software:
standard user tools: web portal and/or mobile application
field audit tools: web-based survey application, a mobile survey application and a netbook survey application
executive management tools: web-based dashboard and reporting applications

Manage Quality with Robust Monitoring and Reporting

The disclosed technology provides executives and management with the real-time dashboard monitoring and reporting capabilities across all locations and personnel. The disclosed technology makes it easier to obtain a current and accurate snapshot of how the overall organization is performing against established policies and guidelines set by the management team. Data can be filtered and analyzed through an endless number of reporting capabilities such as how one brand is performing against another or how the west coast compares with other regions in the country. It is all available in real time for the user's team to view, analyze and act upon.

Management can also use the system as a communications framework for delivering new policies and procedures into the field in real time. New descriptions of policies and procedures can be quickly and easily added to the system with instant alerts sent out to relevant users. It is further contemplated that these alerts will be able to be delivered in multiple formats—as written text, as visual imagery and/or video—to assist employees in better understanding new directions for implementation. Field auditors will also be able to upload images and documents to show management actual tactical examples of how decisions are being interpreted, both properly and improperly.

Increase Auditors' on-Site Productivity and Efficiency

Enabling field representatives to perform more audits, more accurately, is a key benefit to the system. From preparation and audit walkthrough to compliance walkthrough and final review, the disclosed technology enables auditors to increase productivity, save time, reduce paper, avoid penalties, streamline workflow, reduce data entry errors and improve communication. Auditors can now see their schedules ahead of time, access and/or download relevant information for pending site visits (such as personnel information, special competencies, historical performances, outstanding issues/citations, previous auditor notations, etc.) allowing for the actual time on site to be as minimal and efficient as possible.

Accessible from three portals—through the web, through a mobile app or via a netbook, notebook or laptop, among other portable or non-portable devices—the disclosed technology's survey tool provides auditors with an easy-to-use, paperless, automated interface from which to conduct audit and compliance walkthroughs. The survey tool also gives the organization's management control over customizing survey questions and content, ratings and other settings—as well as the ability to make changes quickly and easily, system-wide.

Users may choose to access the disclosed technology via laptops, online or offline. When working offline, the application will sync data with the database when an Internet connection is re-established. This ability to operate the disclosed technology locally offers additional functionality and flexibility when an on-site Internet connection is not available.

In one configuration, the disclosed technology is implanted over the internet using a web browser. All that is required is an internet connection and a browser such as Internet Explorer, Mozilla Firefox, Opera, Chrome, etc., to access the web-based implementation of the disclosed technology.

The disclosed technology can accommodate an unlimited number of users, and user roles can be customized, defined, updated, added, deleted and edited as needed. Permissions can also be customized per role, to define or limit access to specified content. Users can also be assigned multiple roles.

The disclosed technology provides pre-defined users with the ability to dynamically create an unlimited number of their own surveys, questions and scoring criteria, as well as to track versions of surveys and questions so that a full history is always available for reference. This degree of control and flexibility increases efficiency and accuracy across the organization's audit program.

The disclosed technology enables users—both executive and general users—to customize reports based on their organizations' needs. Reports can be created based on anything from survey results to auditor efficiency and performance to location activity or any other data management wishes to extract. Reports can be exported to Excel (.csv) and PDF.

The user experience can be branded and customized to reflect the user organization's logo or color palette. The disclosed technology is scalable so it is accessible and ready to meet each individual company's size and growth.

Compliance Management Scenario

The disclosed technology is flexible, and may be adapted to incorporate branded login and messaging

Easy to use web-based and mobile application tools make the system a real time communications platform.

The disclosed technology's reporting dashboards give executives a clear view of what is happening in the field so they can monitor their compliance and quality assurance issues more effectively.

Executive Dashboard

Features of the executive dashboard include real-time reporting.

An installation/employee dashboard enables immediate compliance reinforcement. To this end, a document manager is provided. The administrative manager's tools include:

“Locations manager”

“Add a location”

“User manager”

“Add a user screen”

“Add a role screen”

“Criteria manager”

“Question manager”

“Add a question”

“Manage question scoring”

“Audit manager”

“Create a new audit”

“Create an audit—add sections”

“Create an audit—add questions”

“Conduct a quick audit”

“Take a self-assessment”

“Individual audit question”

The disclosed technology allows the user to schedule an audit/tour. Additionally, the disclosed technology provides a help desk to aid in answering questions. The disclosed technology further offers mobile compliance, for example through a real-time mobile audit application for a portable mobile device. In addition, computer (desktop, laptop, netbook, tablet, etc.) applications can be used.

Architecture Overview—Solid SaaS Architecture with adaptability allows the disclosed technology to be utilized by and work for a variety of industries and applications

Implementation

There has been a significant increase in the need for compliance and oversight across a broad range of industries, many of which did not have any of those requirements placed upon them before. The need to develop a data-driven, real time compliance process is higher than ever. Currently, there are few compliance management techniques that allow for quick deployment and simple customization and yet still provide real time data delivery across multiple devices. The majority of the marketplace is niche to an industry and many are still not fully real time or providing mobile compliant tools.

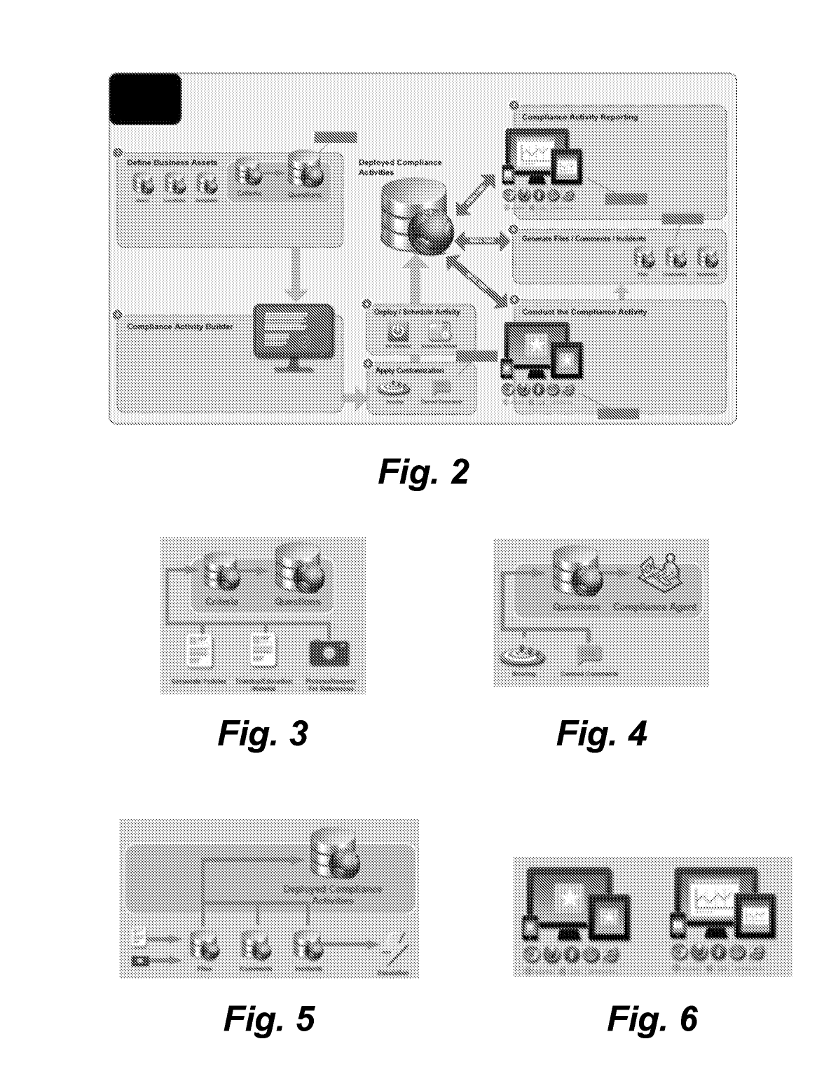

FIG. 2 is a diagram showing an overview of the disclosed technique and how it helps to solve the above problem. There is a progression through which the platform is initially set-up for a business/organization and then once established, the ability to generate the necessary compliance tools and deploy activities becomes very easy and quick to deploy. Its uniqueness revolves around its flexibility and adaptability to almost any compliance situation or requirement.

In step 211, business or enterprise assets are defined. Owner/Administrators of the system can set-up the necessary variables that meet their business needs. Users, locations, and pre-canned audit templates, are added into the system for ready use when it comes time to build the necessary compliance tools. Questions can be entered into the system and then “criteria” can also be added and then “connected” to a question to support a variety of business needs.

In step 212, compliance activity is built by using the assets of the system to “build” their compliance activity, or establish a compliance activity plan. Owner/Administrators/Authorized Users of the system can now use the assets of the system to establish the compliance activity plan to include their compliance activity (i.e. survey, audit, checklist, etc.) and then either assign and deploy it immediately to be given or schedule it for a pre-determined time and place. Either way, the person conducting the activity gets immediately notified and then has the ability review all aspects of the activity. They can review the questions, scoring, criteria associated, etc. They can also request modifications back to the compliance author or make them themselves depending on permissions.

In step 213, customization is applied. The customization can optionally include an application of question scoring, in which questions can be given unique scoring ranges based on business needs and adjusted from one activity to another when necessary. In addition to customization, canned comments may be incorporated, which, by way of non-limiting example, be generated in accordance with the data previously received in steps 211 and 212, or from information obtained from previous audits.

In step 214, schedule activity is deployed or scheduled. This can, by way of non-limiting examples, be scheduled ahead or performed on demand. This results in deployed compliance activities 220. The deployed compliance activities can be implementations of conducting compliance activities (step 231), generating files or incidents (step 232) or compliance activity reporting (step 233). These procedures 231-233 can be performed in real time as real time implementations of the compliance activities.

In step 231, compliance activities are conducted. The designated compliance users (e.g. surveyor, auditor, quality manager, etc.) of the system can now conduct their compliance activity using any of the tools that work best for the given situation. Use of handheld mobile devices, tablets or laptop/desktop stations can work as well. The compliance agent can go through, answer all items, review connect support materials if needed. They can also attach files related to a question or activity, they could take pictures and attach as well specific to a question and/or activity overall. In addition, the compliance agent can initiate an “incident” that is associated with a specific question or the activity overall. The incident then allows for predetermined paths of escalation within the business.

In step 232 generating files or incidents are generated. This can also be the outcome of the compliance activities performed in step 231. Files, comments and/or incidents that a compliance agent generates, become “specific” to that question result and/or compliance activity. All participants in the process can have access to materials related to the compliance activity and issues related to the compliance activity. This generates files 241, comments 242 or incident reports 243.

In step 233, reporting of compliance activity is performed. Once compliance activities are deployed, conducted and recorded, the information becomes immediately available for reporting within the platform. The information provided is viewable across a multitude of both mobile and desktop devices across multiple operating systems. Therefore access to critical quality control, compliance and management information is available nearly instantaneously.

FIGS. 3-6 are diagrams depicting aspects of the disclosed technique of FIG. 2. These features, when combined, are very effective in providing for quick and easy set-up and deployment for compliance required situations. As a result, without a great deal of customization and large expense, business organizations can utilize these unique components to establish a real-time compliance management system quickly and affordably.

FIG. 3 is a diagram showing the relationship between the compliance criteria and questions asked of the user. Any question added to the system can then have criteria attached to it so that when a compliance agent is conducting an activity, or any end user is reviewing the activity results, they can connect to those criteria.

Criteria are added into the system by an administrator and can be made up of anything that fits the need of the business. It could be a set of corporate guidelines that is broken down into specific parts for access. Criteria might be support or training related material describing the proper procedure or process steps for a particular subject. The criteria might also take the form of pictures or images showing how something should be displayed or set-up.

The ability to connect criteria to questions which then are transferred through to the final compliance activity and results makes the platform an invaluable tool for reinforcing business policies and procedures, training and education applications within the business enterprise and or communicating and distributing valuable updates for a variety of business applications.

This flexibility gives the software the opportunity to be utilized in a broad range of industries and roles and not be considered stuck in a niche market.

FIG. 4 is a diagram showing the relationship between the questions asked of the user with comments and scoring. The software's activity scoring relies on a per-question scoring model. This model provides the flexibility to configure a system wide minimum, maximum and default value for a compliant, non-compliant and not applicable answer values. From the defaults, when creating or editing questions, the admin level user is able to assign scoring values between the previously mentioned ranges. Upon completing an activity, the score total is calculated per question based on the score values and the answer the compliance agent selected and subsequently stored in the database. Based on this model, a completed activity's score could be negative or positive depending how the compliance agent answered the questions and how an admin level user weighted each of the questions three answer types (compliant, non-compliant and not applicable).

Additionally, text at the activity level can be associated with a given score value, based on a scoring range. This text is configurable by an admin level user while building the activity. Upon completion, if the activity's score falls in one of the user defined ranges, the text will show on the activity report if the user's activity Template contains the merge field for the scoring range.

Comments can be preloaded for any question or set of questions within an activity. This allows for frequent comment responses to easily be added by compliance agents where appropriate.

FIG. 5 is a diagram showing the use of the generated files 241, comments 242 or incident reports 243 and deployed compliance activities 220. During the compliance activity, the compliance agent who is conducting that activity can at any point during recording an answer for a question, attach a file, add a comment, or initiate an “incident”; all of which then becomes specifically tied to that question and/or compliance activity.

During the compliance activity, the compliance agent who is conducting that activity can at any point during recording an answer for a question, attach a file, add a comment, or initiate an “incident”; all of which then becomes specifically tied to that question and/or compliance activity. Items such as forms, documents, or even photos can be attached as reference material to the question. The items then become stored in a file manager Module for future reference/look-up if need be. Comments can be applied to the question response by the compliance agent either by typing in a free form comment and/or selecting from pre-canned comment options if they have been added to the question and/or compliance activity form.

If the compliance agent sees an issue that they feel requires immediate and/or closer attention, they can initiate an incident specific to the question and/or compliance activity they are conducting. The incident is a description of the problem with all associated fields and material and is submitted into an incident manager module which then follows a path of escalation. The path of escalation is established by a Compliance Administrator and those paths can be customized for specific types of issues. Alerts and notifications are sent out based on the setting that have been put in place. The incident persists within the system until it becomes resolved.

FIG. 6 is a diagram showing the implementation of audit conducting and reporting tools. Since the platform is server based as a Software-as-a-Service (SaaS) model platform, the platform allows for the various end users (i.e. compliance agents, schedulers, business stakeholders, executives, etc.) to utilize a wide array of devices, operating systems. As a SaaS model platform, the system at its core is web-based and delivered through a browser. The type of browser, operating system and device is broad in scope, as defined by conventional web protocols (HTTP, HTTPS, etc.). Using mobile phones, mini and full size tablets as well as laptops and desktop computers, the disclosed technique will work where needed and when needed by users. By way of non-limiting examples, the platform can be implemented through Android, Apple iOS, and WindowsMobile as supported operating systems on the mobile side and for browsers, Chrome, Firefox, Opera, Safari and Internet Explorer. This flexibility and breadth of service allow businesses to expense and inconvenience in implementation of specific platform-specific hardware. In most all cases, existing hardware and software can be leveraged immediately.

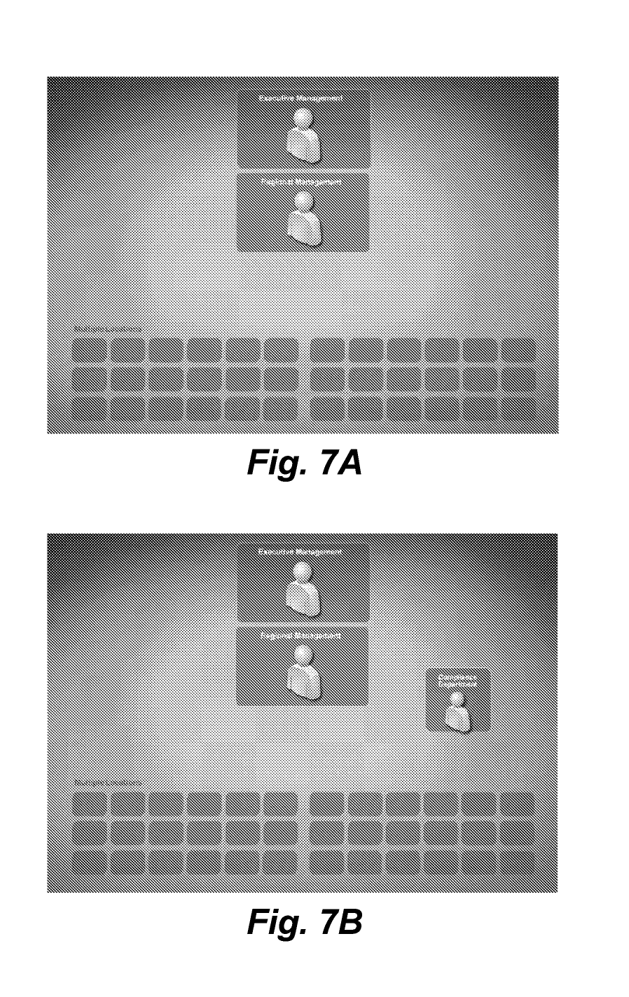

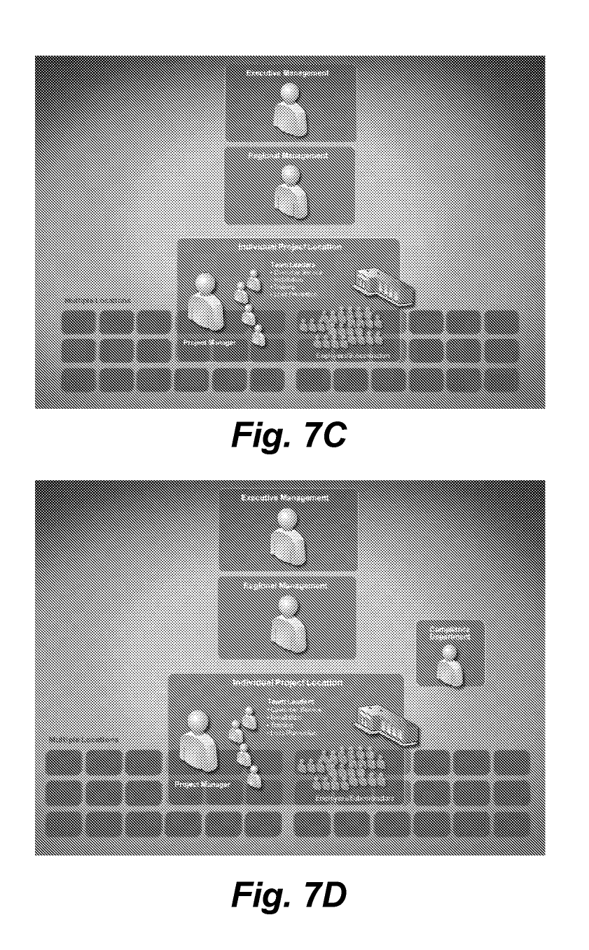

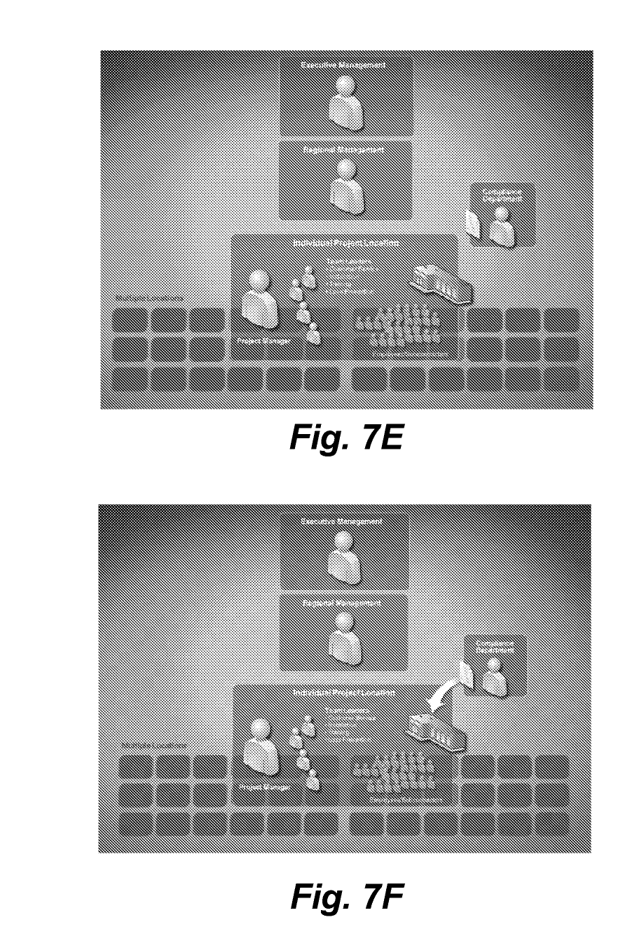

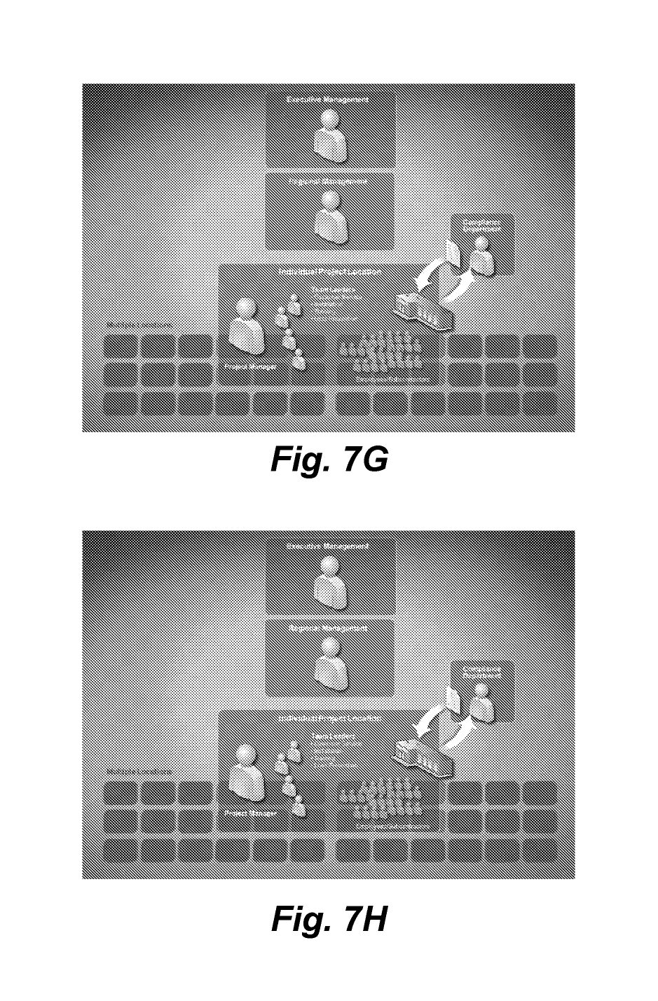

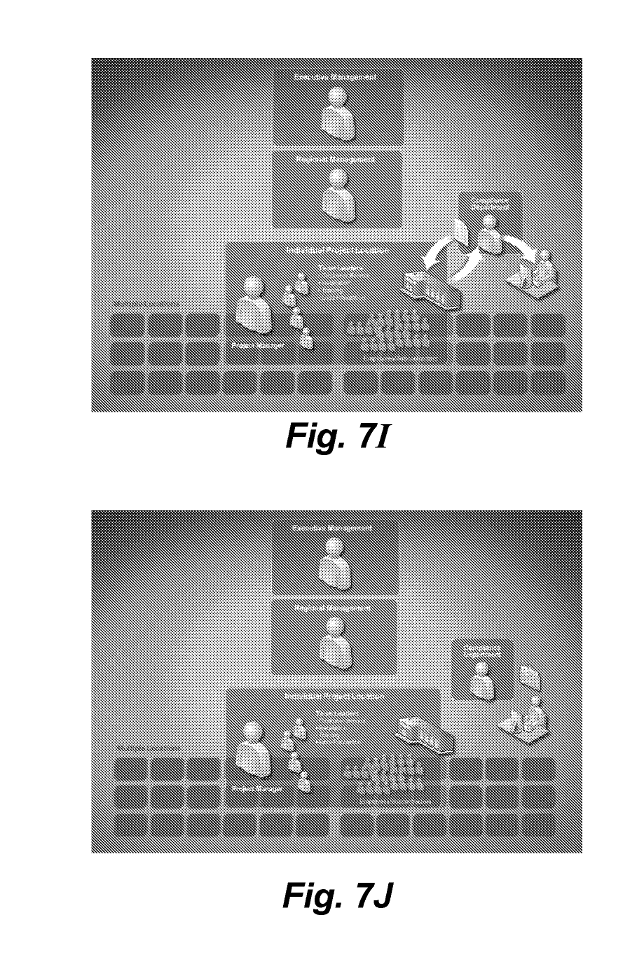

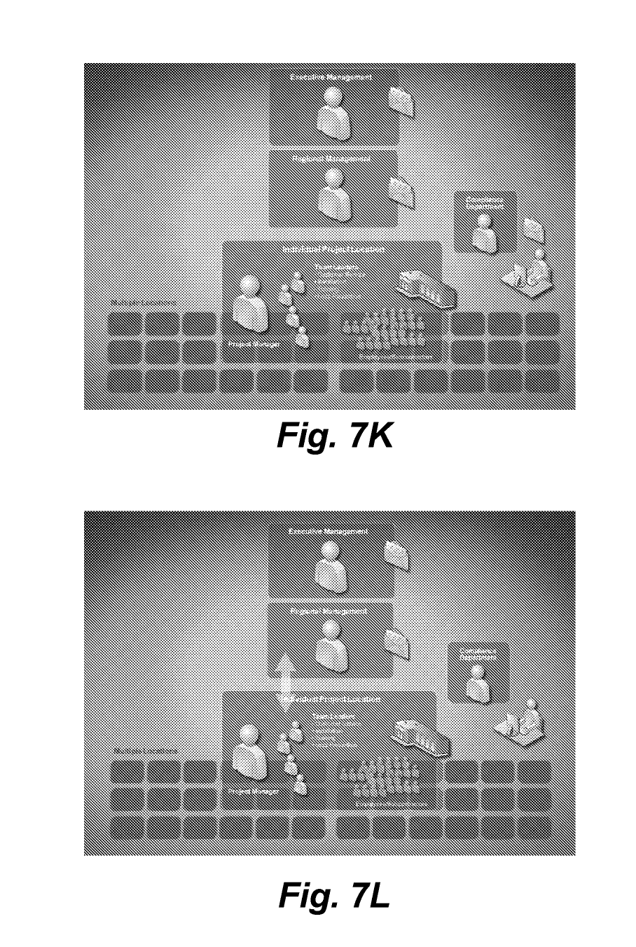

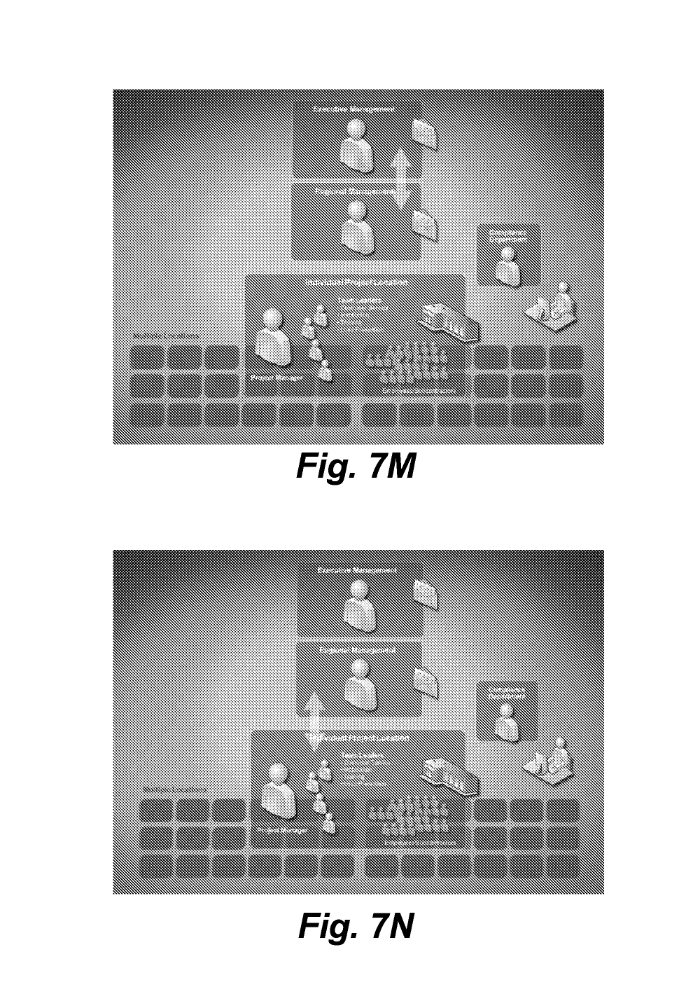

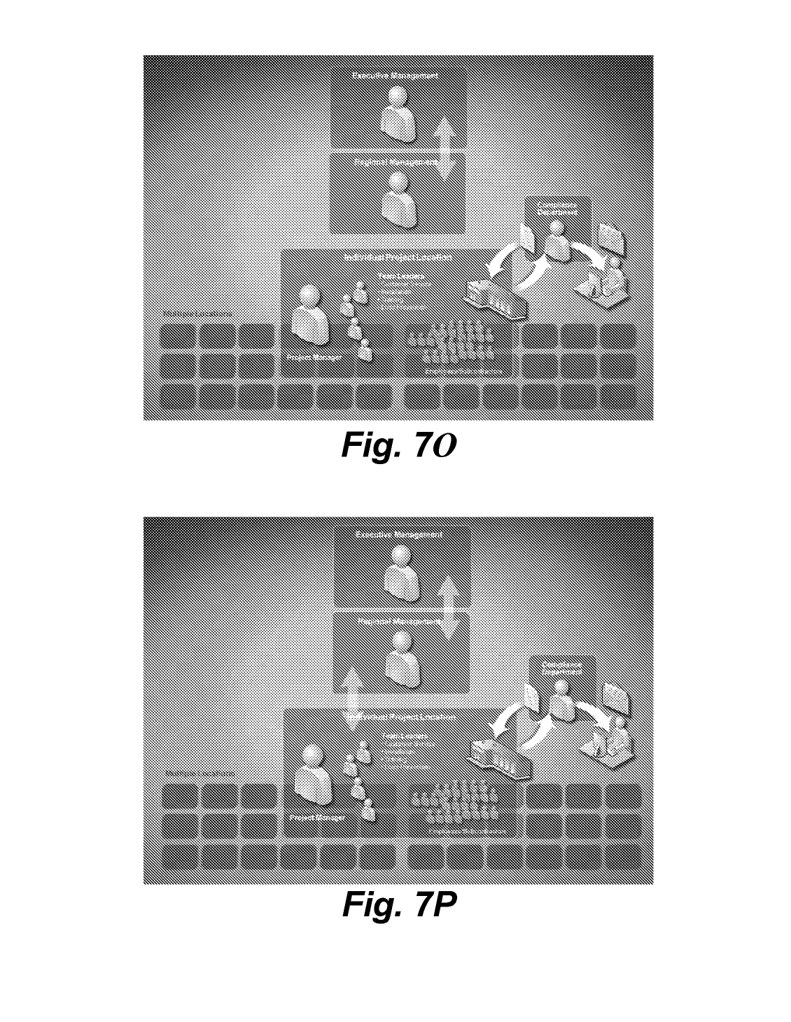

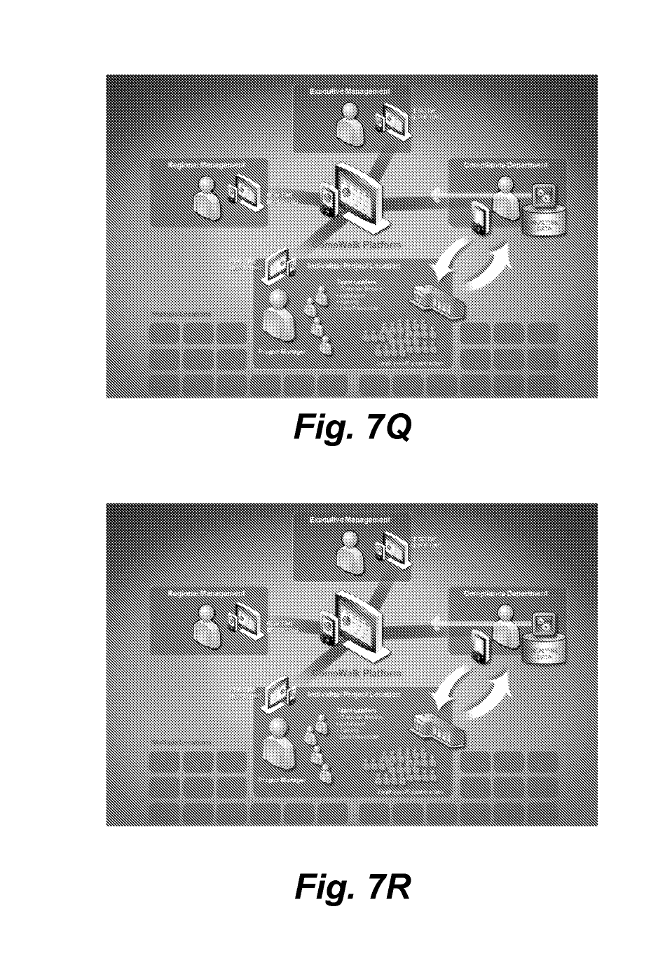

FIGS. 7A-7R are diagrams depicting deployment of the program for implementation in performing audits.

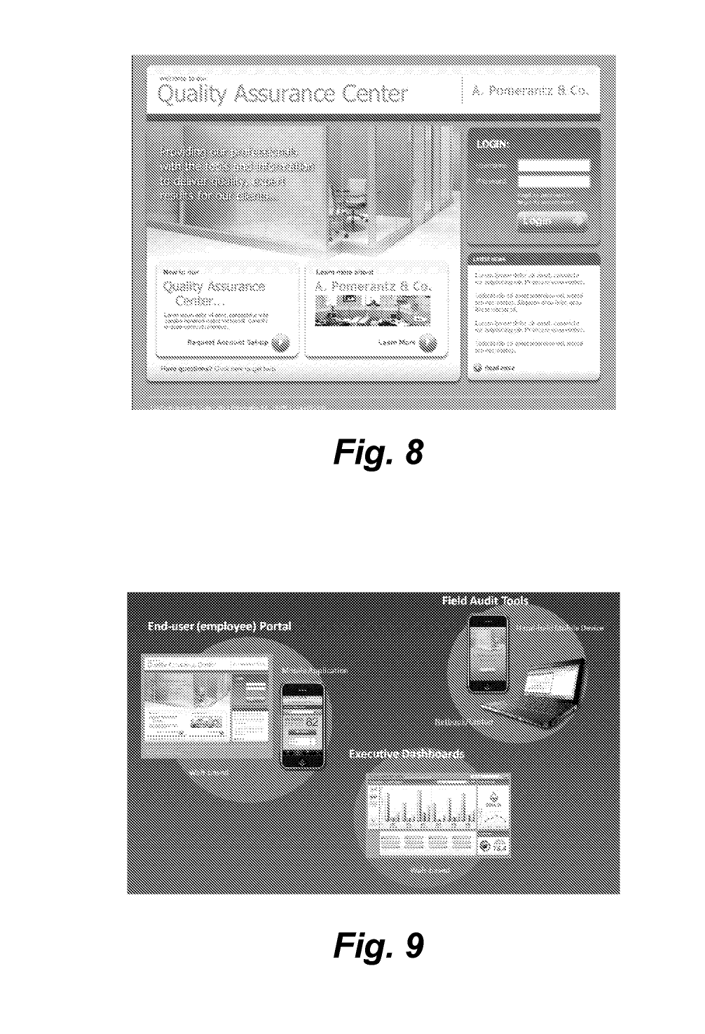

FIG. 8 is a logon screen showing a logon for access for compliance monitoring.

FIG. 9 is a diagram showing connections to the logon for access for compliance monitoring of FIG. 8.

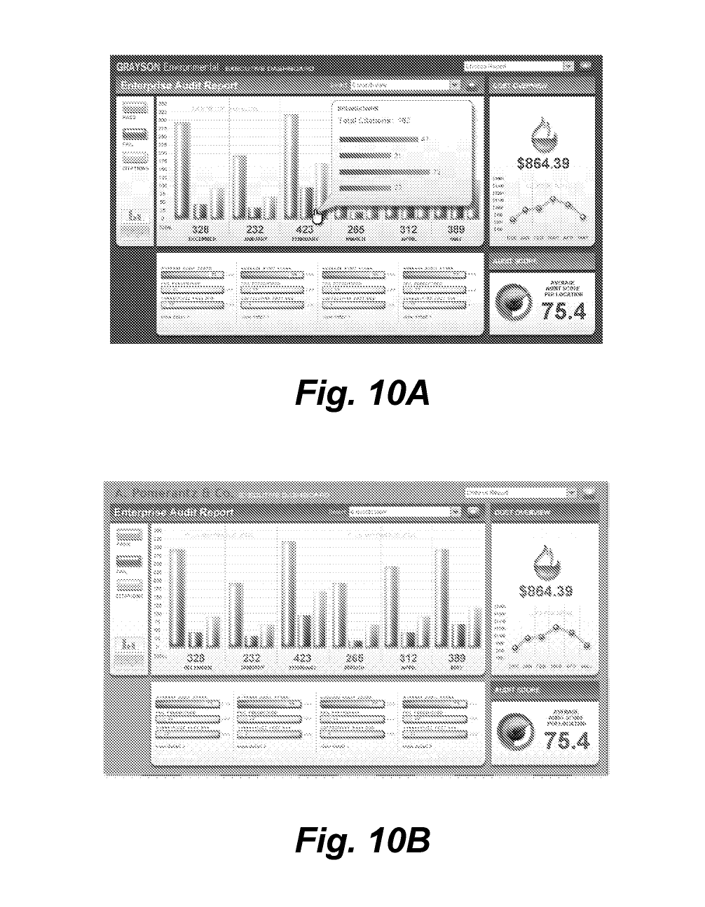

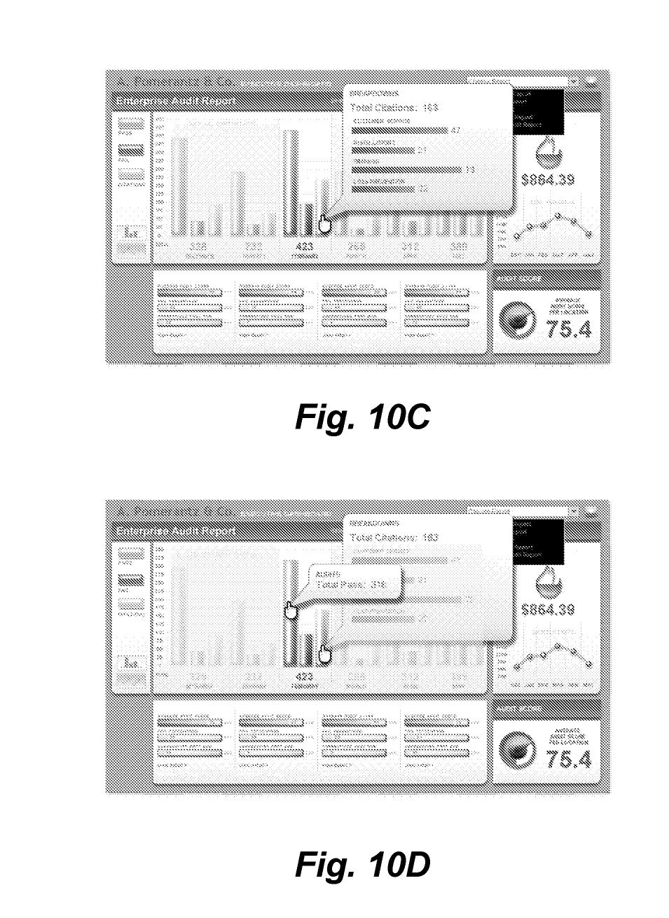

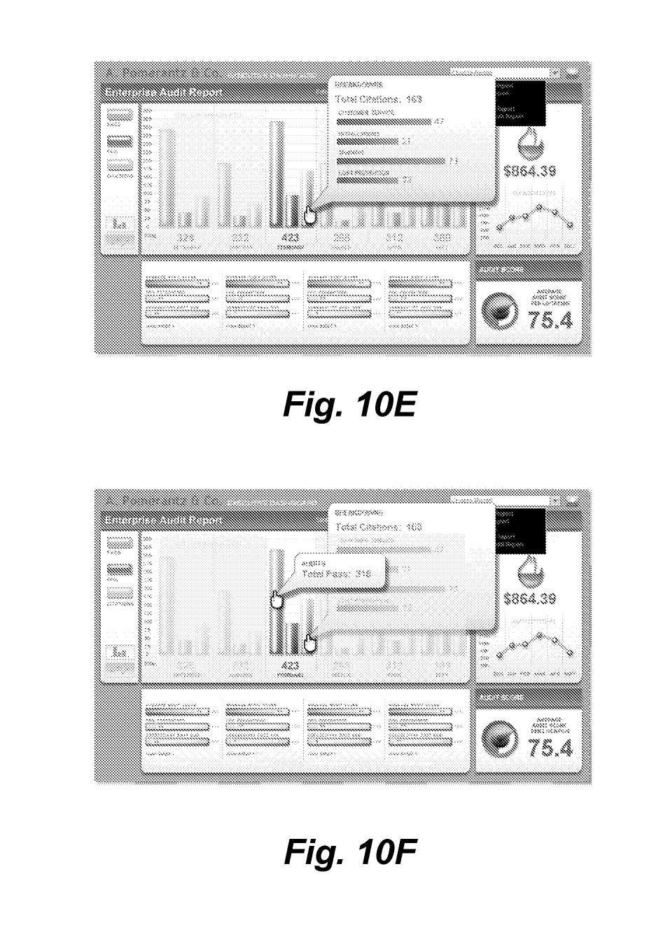

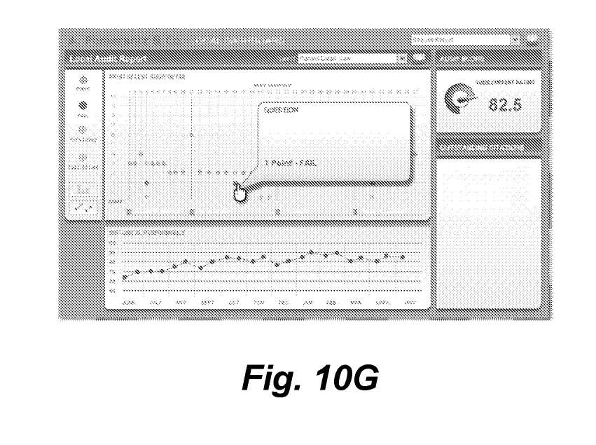

FIGS. 10A-10G are screen images showing the use of compliance monitoring. FIGS. 10A-10F depict an enterprise audit report. FIG. 10G depicts a local audit report used for immediate compliance reinforcement.

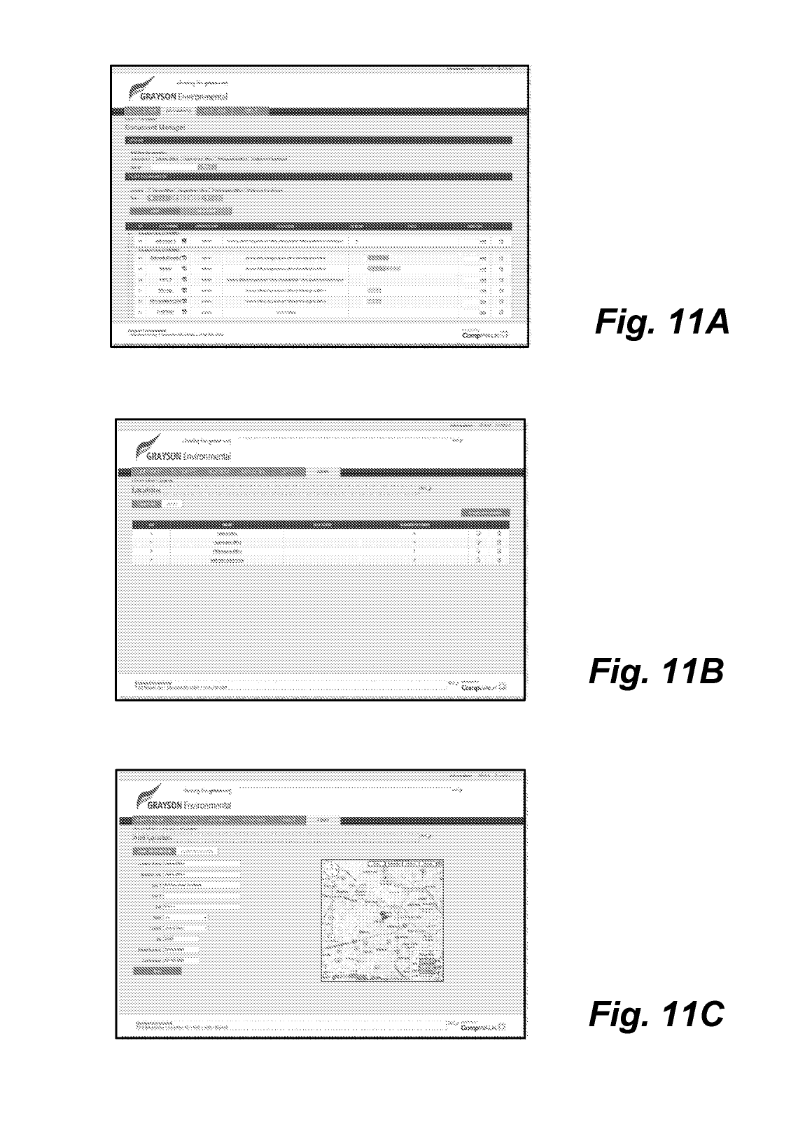

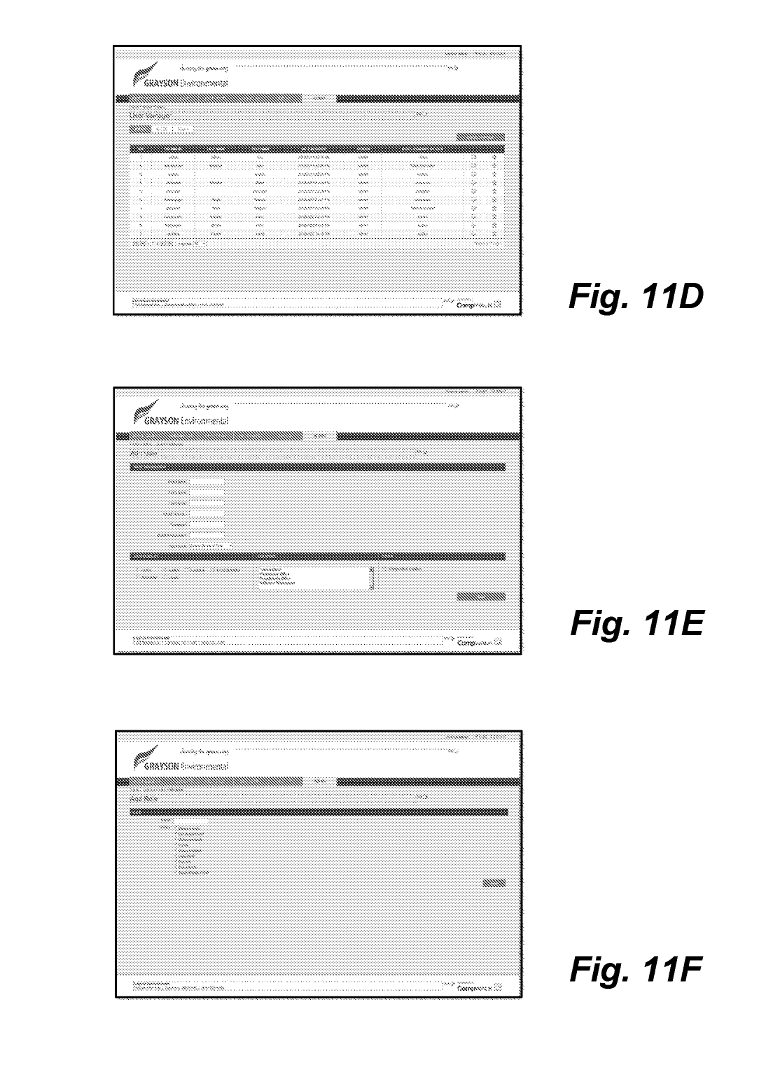

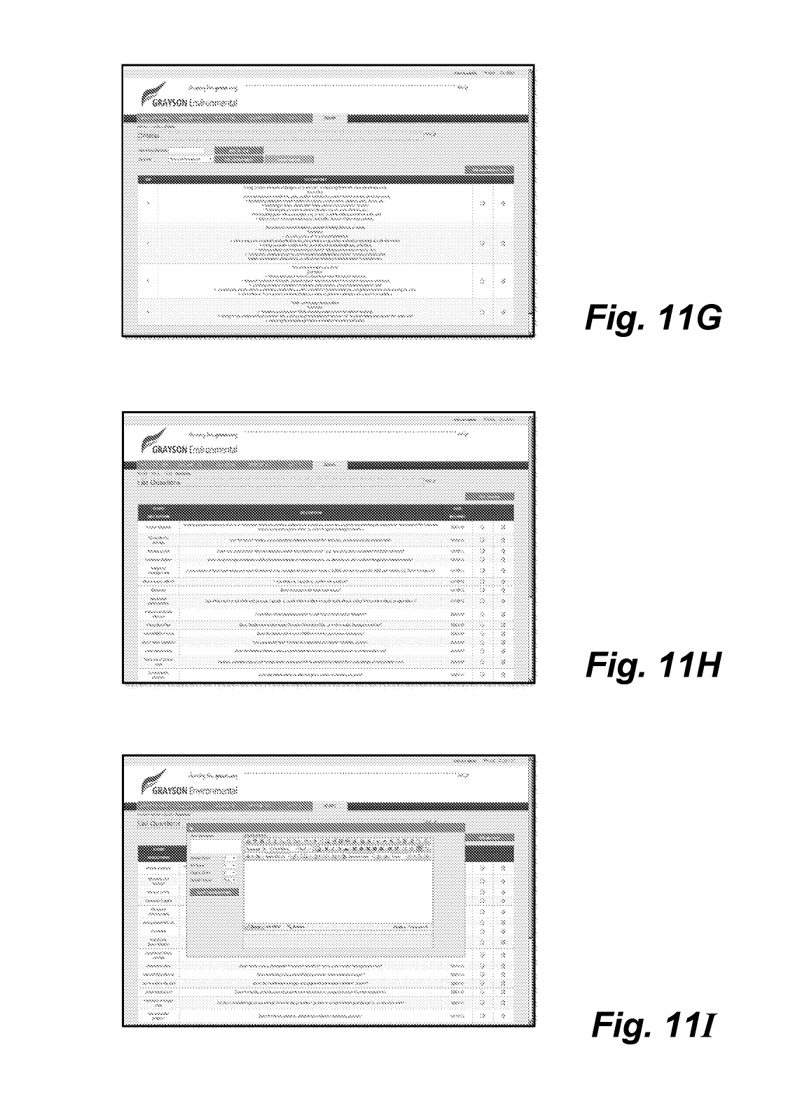

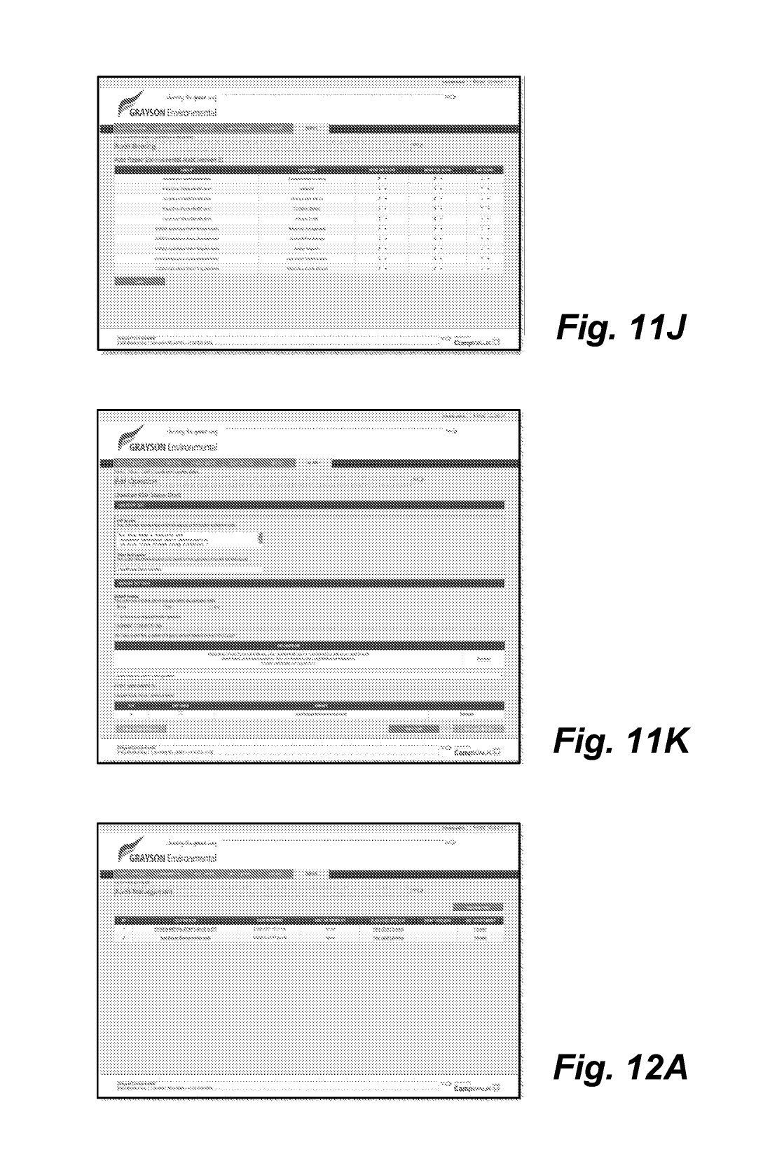

FIGS. 11A-11K are screen images showing screenshots of compliance management tools. FIG. 11A shows a document management tool. FIGS. 11B-11D show an administrative manager “locations manager” function. FIG. 11E shows a screen for adding a user. FIG. 11F shows a screen for adding a role for the user. FIG. 11 G shows criteria displayed for the compliance management. FIGS. 11H-11K show a list of questions used for compliance management. FIG. 11I shows a window for adding a question. FIG. 11J shows a screen for adjustment and display of audit scoring. FIG. 11K shows a screen for editing a question.

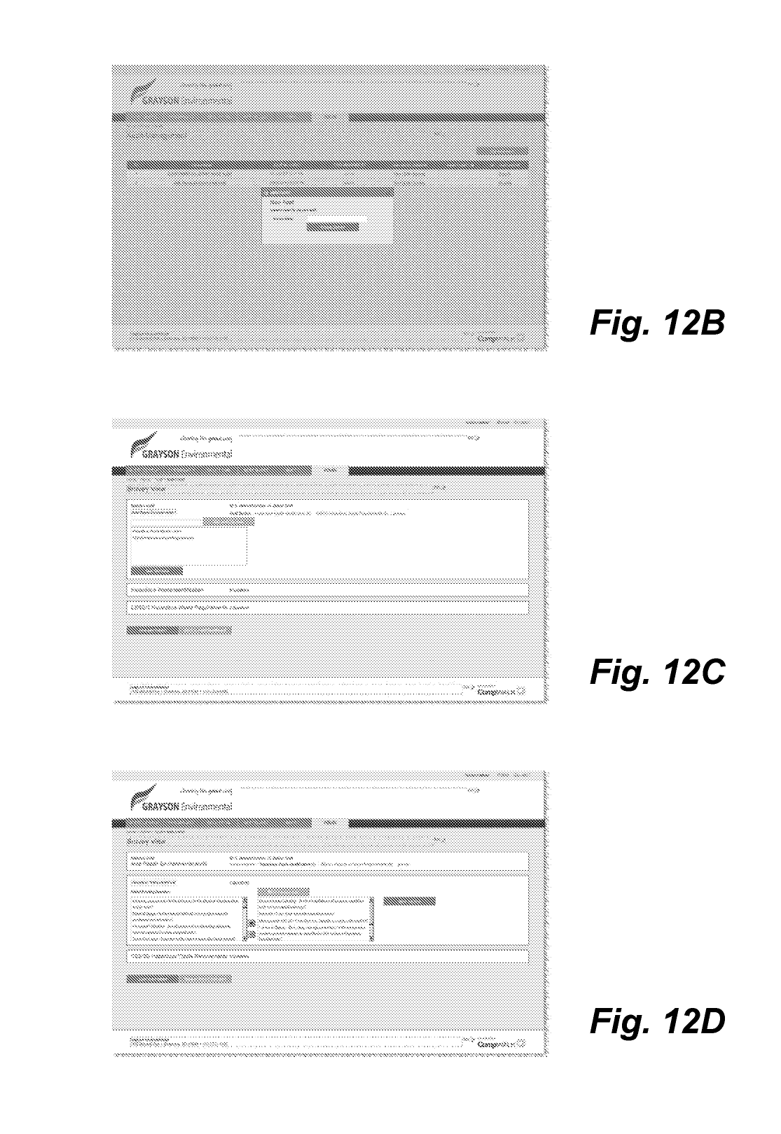

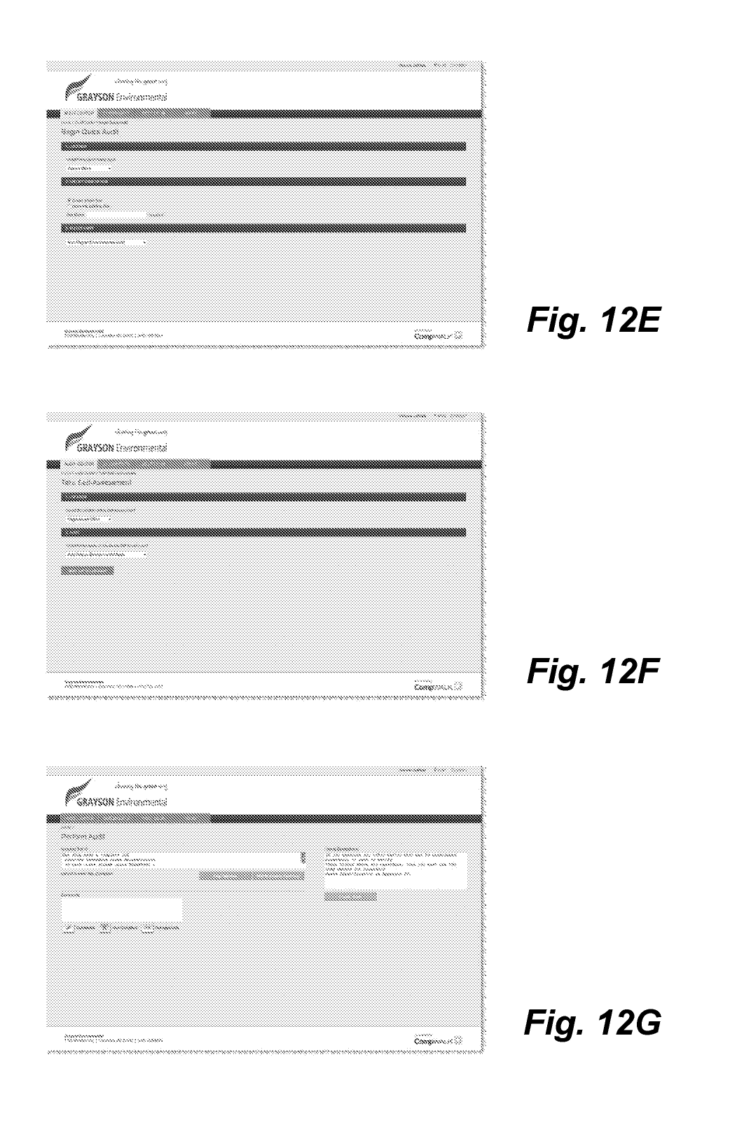

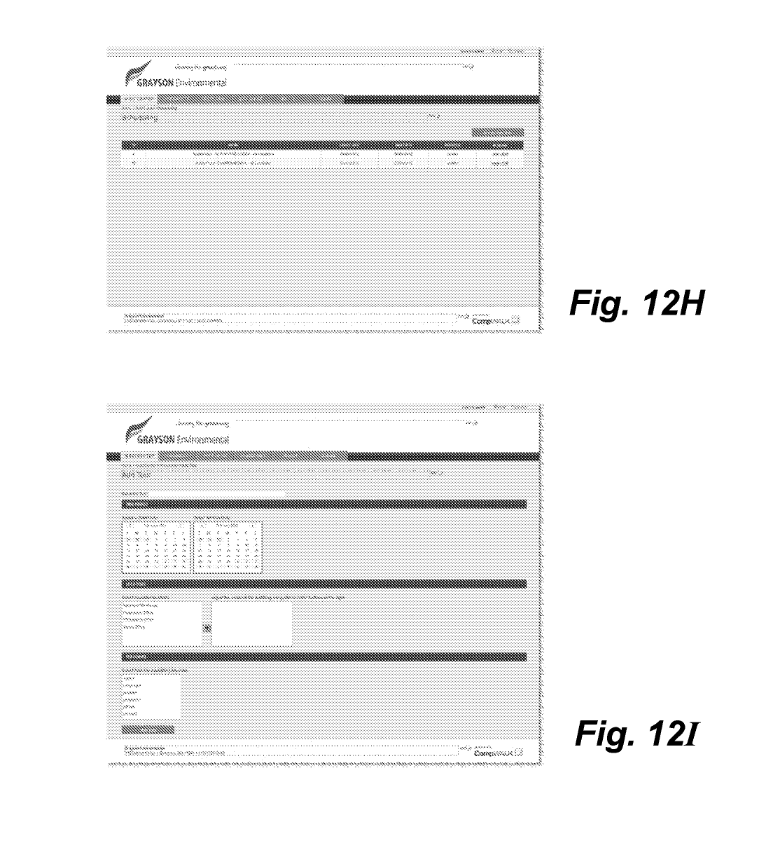

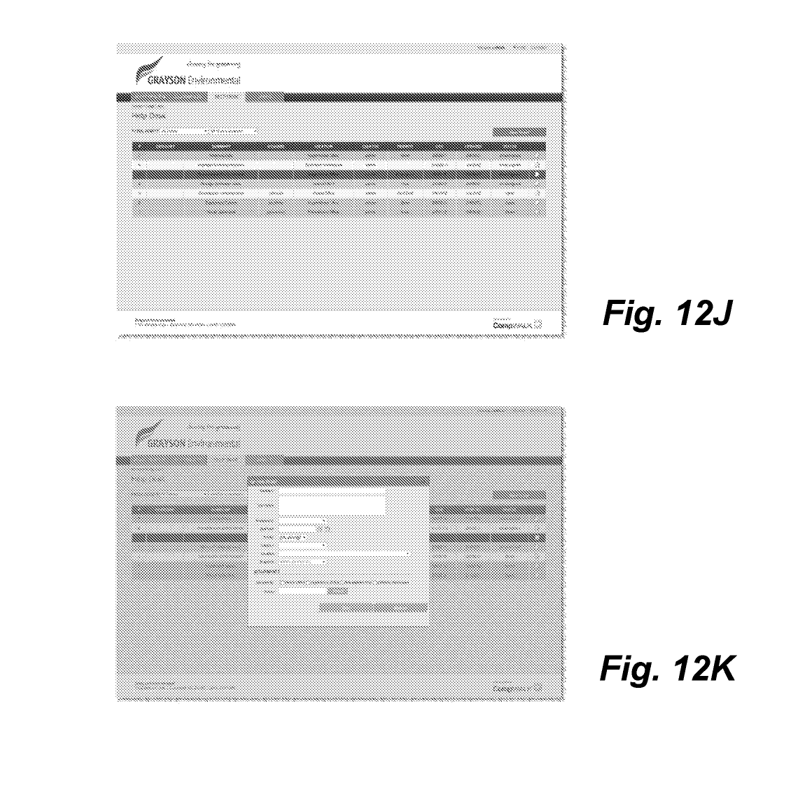

FIGS. 12A-12K are screen images showing screenshots of audit management tools, which are a part of the compliance management. FIGS. 12A and 12B show an audit list and the creation of a new audit. FIGS. 12C and 12D show screens for adding audit sections and audit questions. FIG. 12E shows a screen for conducting a quick audit. FIG. 12F is a screen for the user to take a self-assessment. FIG. 12G is a screen showing an individual audit question. FIGS. 12H and 12I are audit scheduling screens. FIGS. 12J and 12K are help screens.

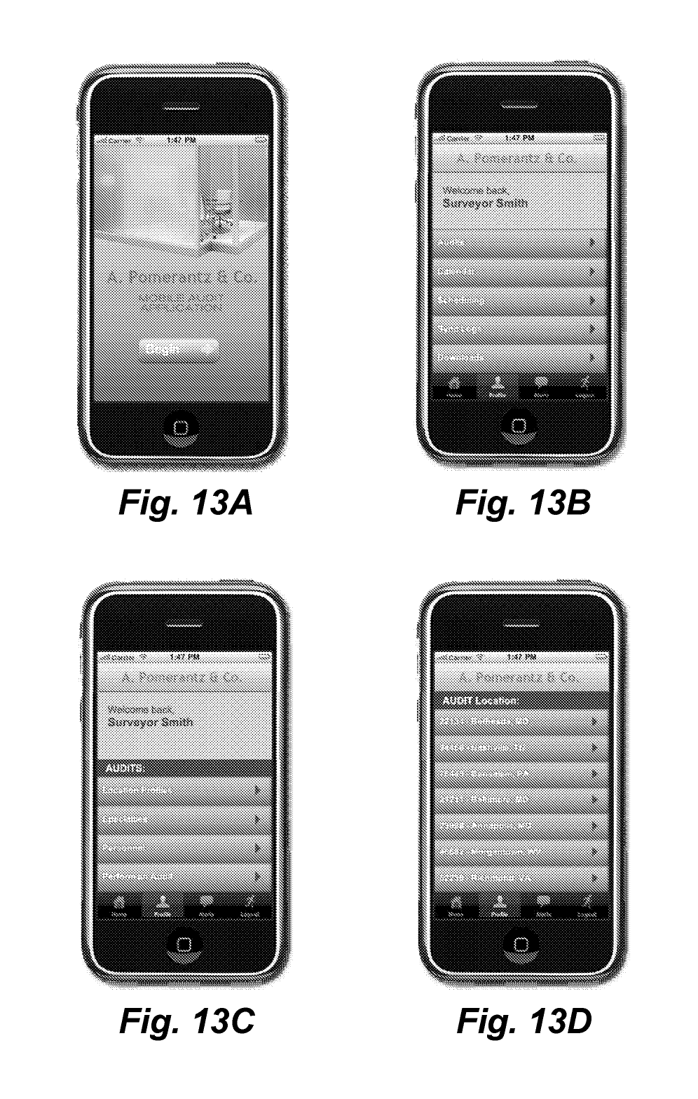

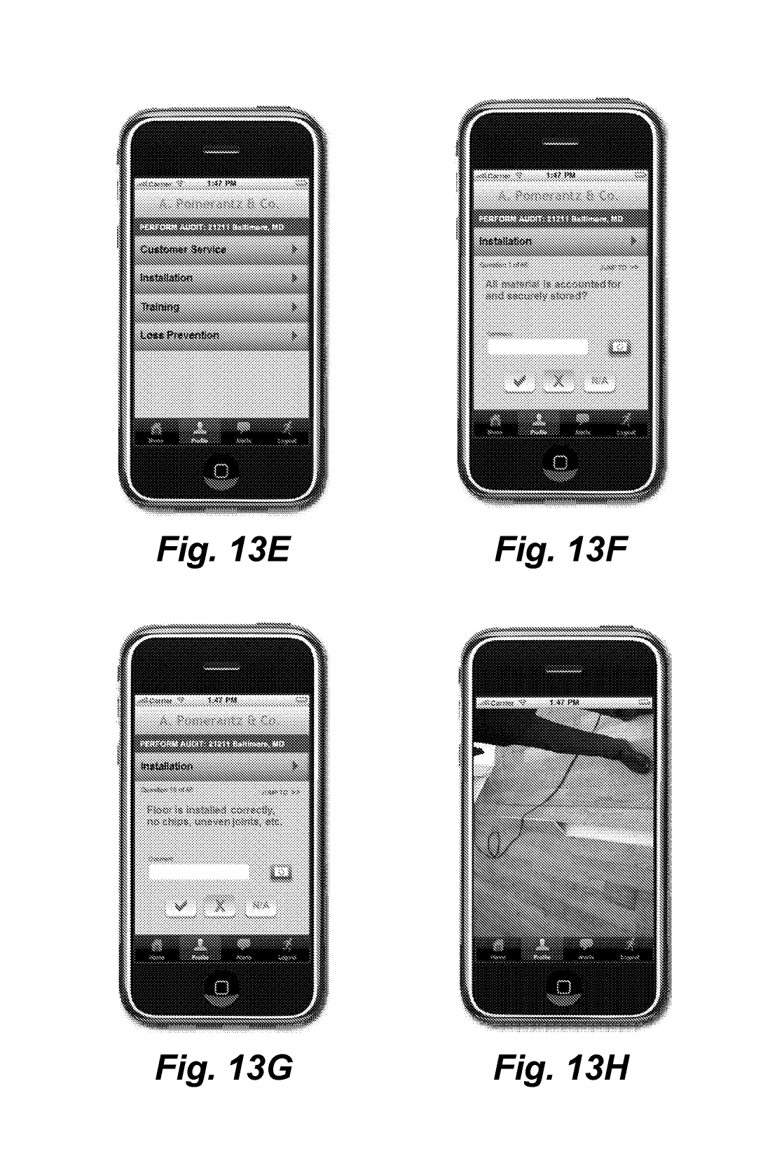

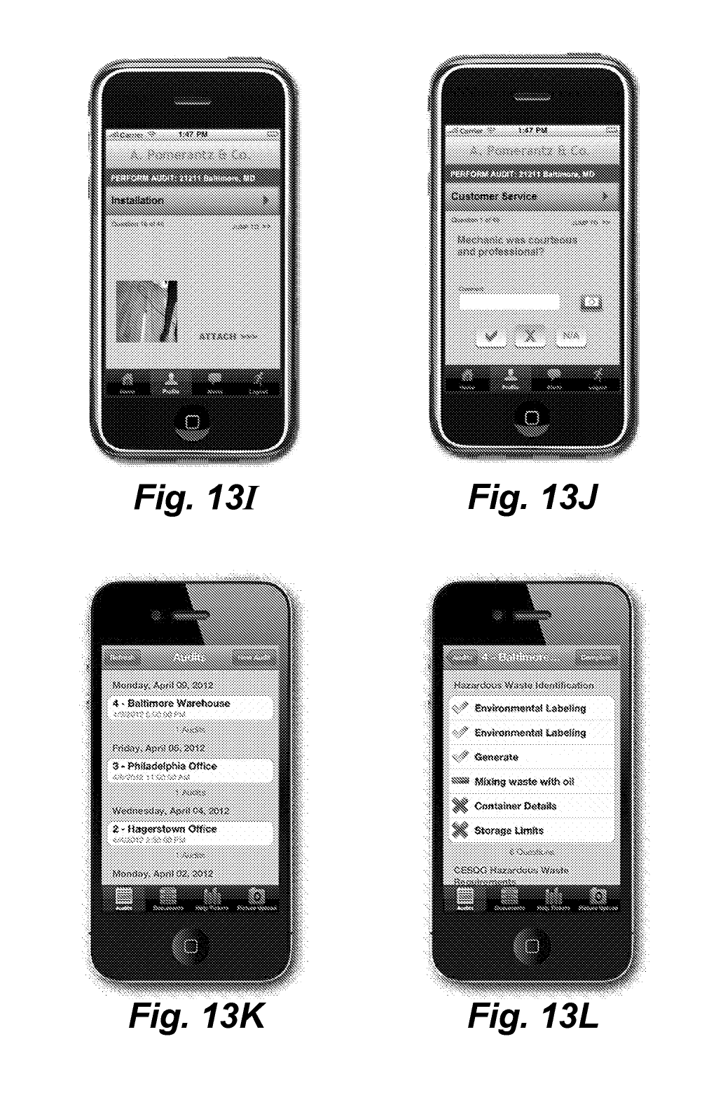

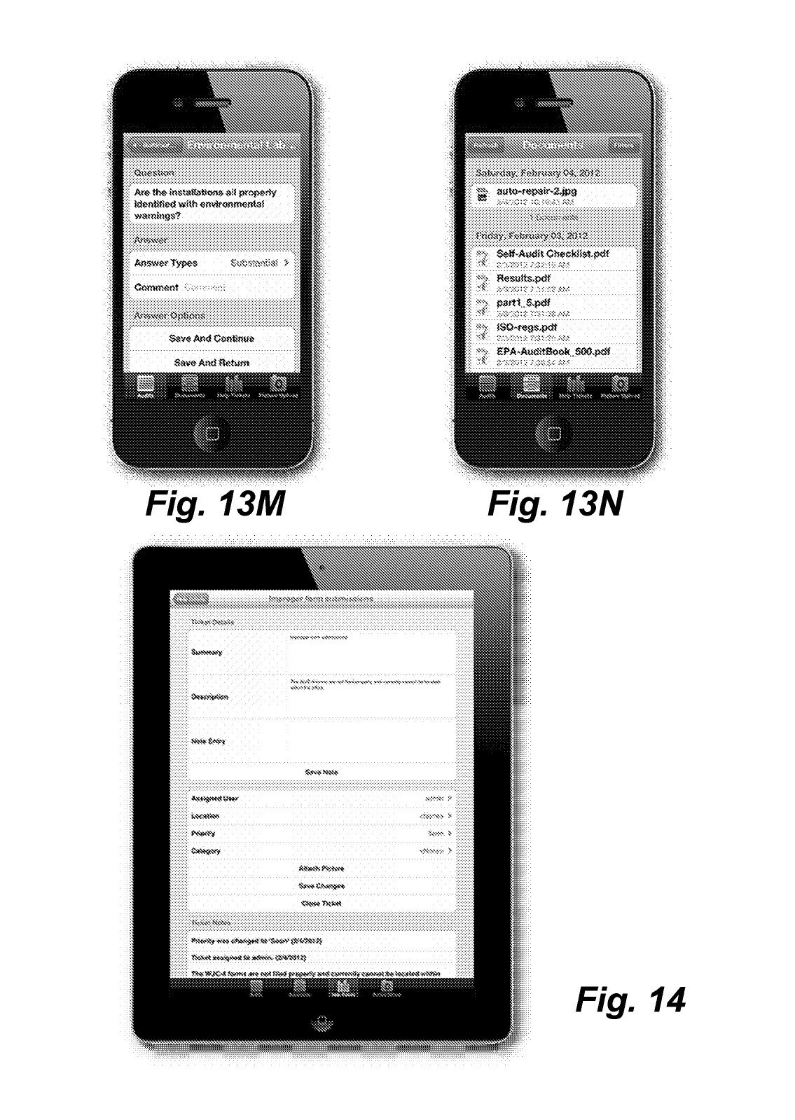

FIGS. 13A-13N are depictions of user interfaces using a first type of smartphone.

FIG. 14 is a depiction of a user interface using a computer tablet.

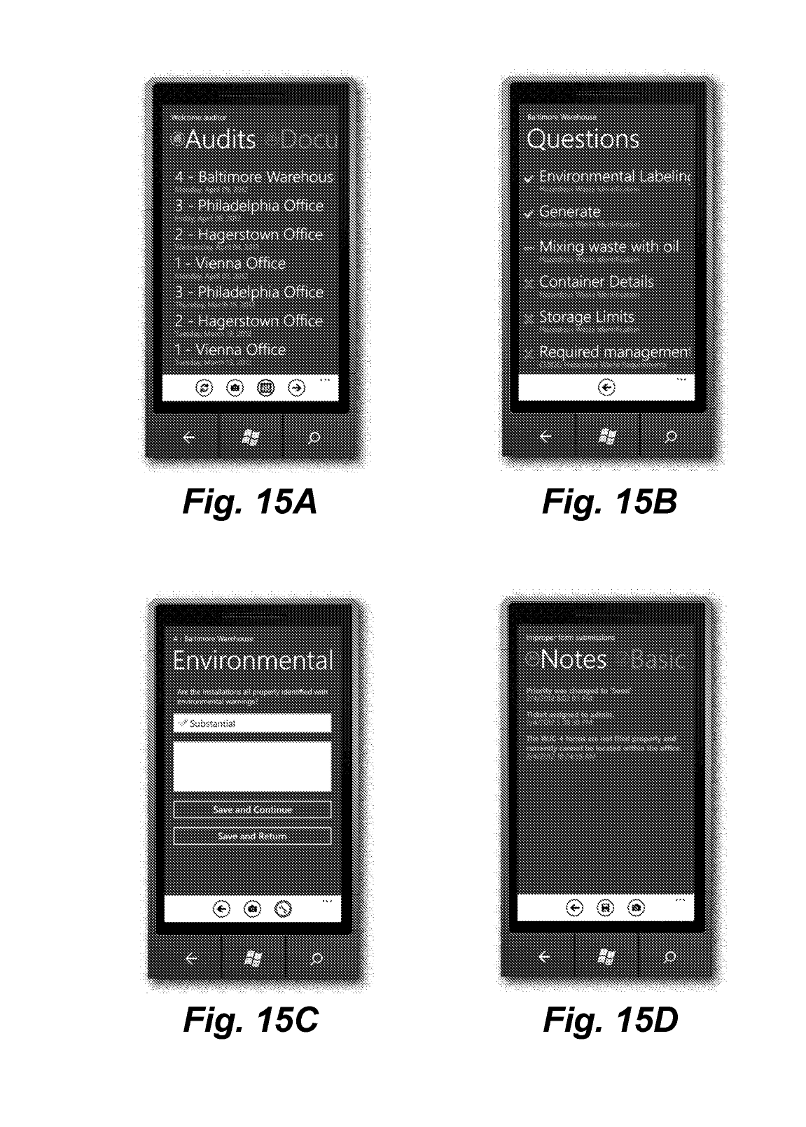

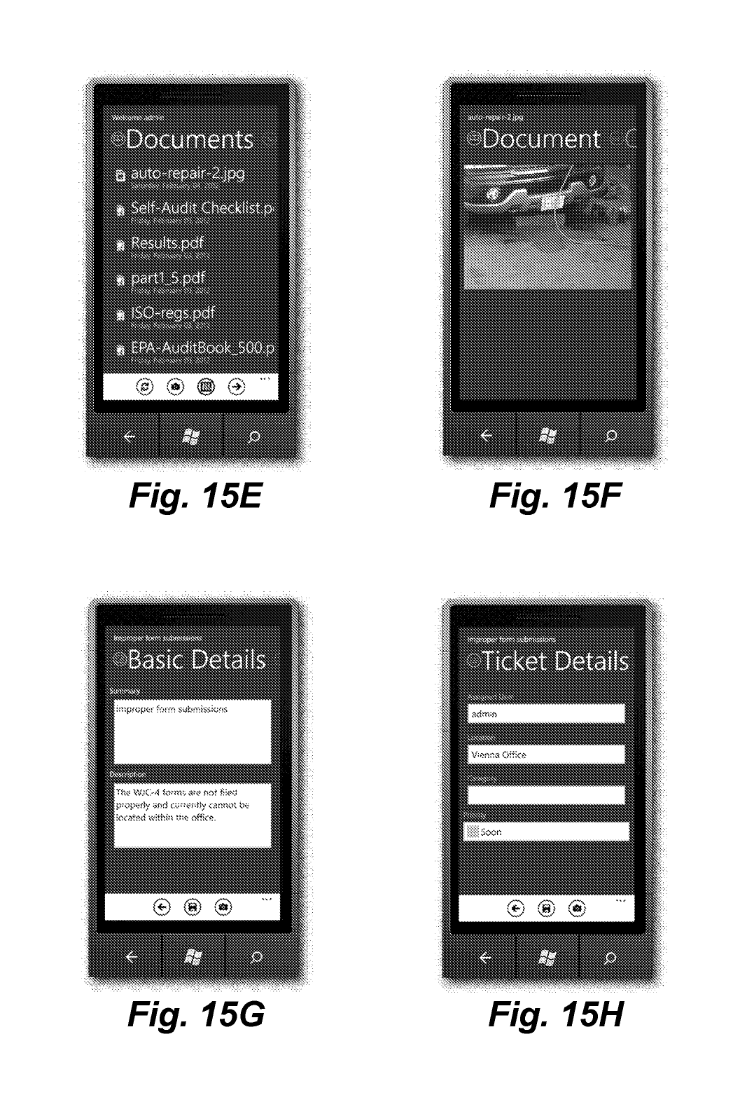

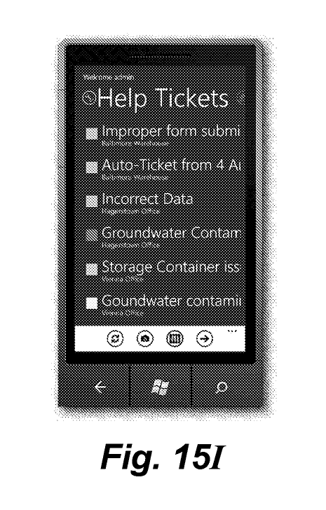

FIGS. 15A-15I are depictions of user interfaces using a second type of smartphone.

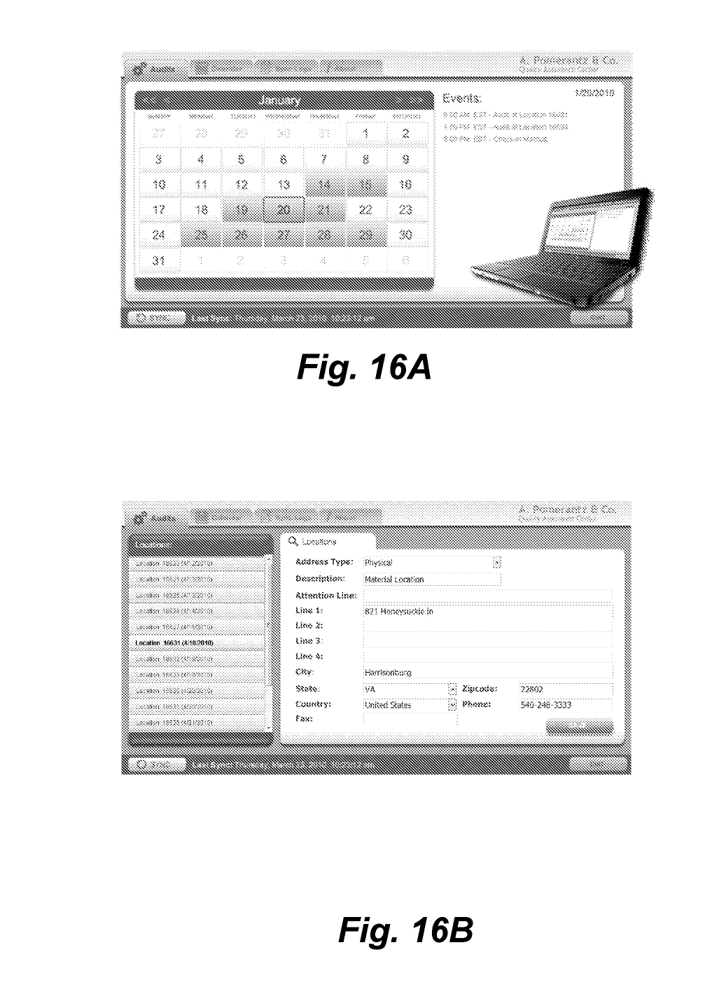

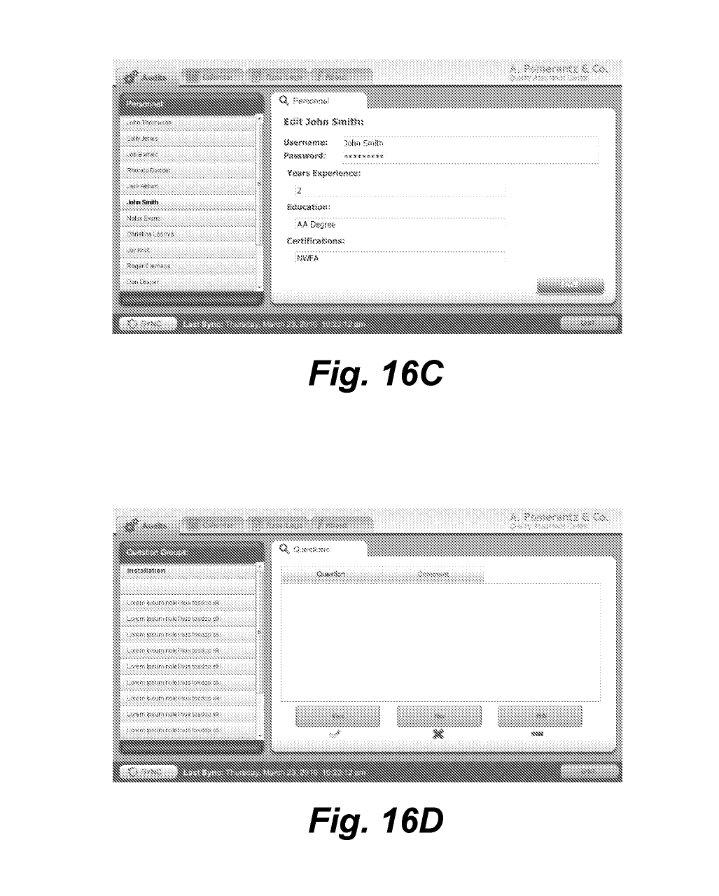

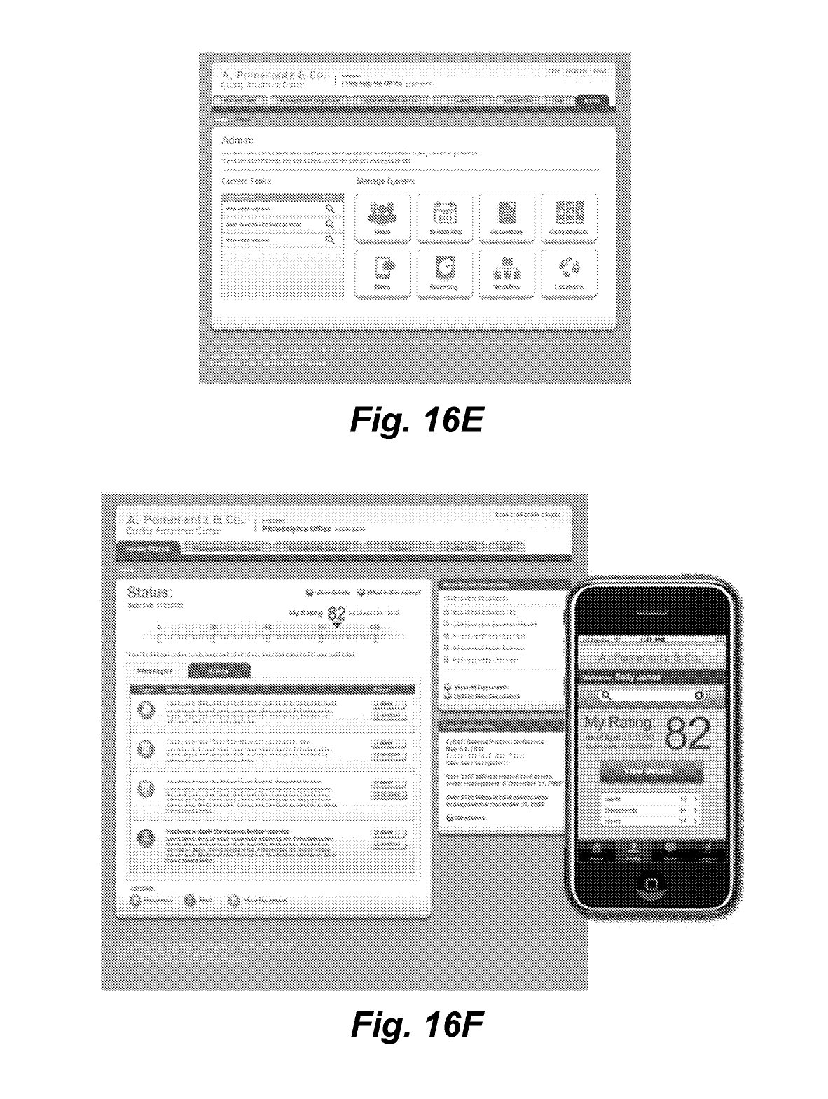

FIGS. 16A-16F are depictions of web-based interfaces for monitoring multiple certifications.

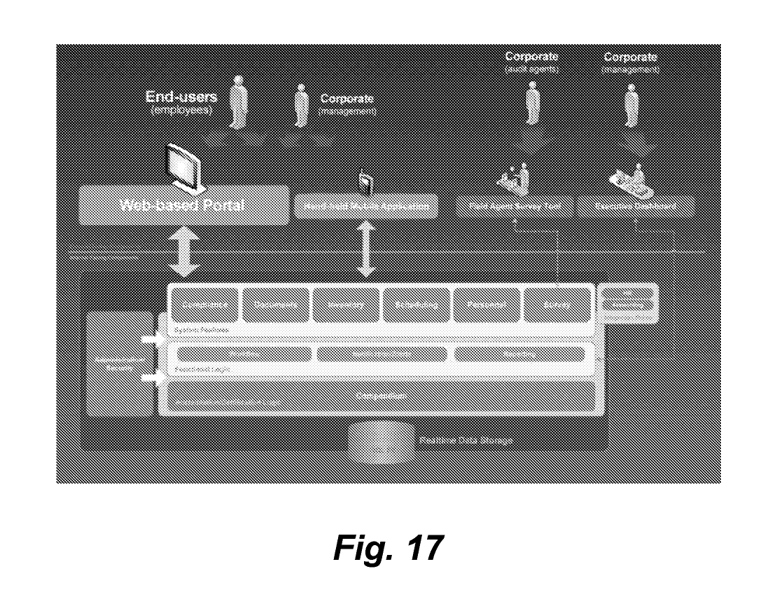

FIG. 17 is a schematic diagram showing an overview of the compliance monitoring system.

### CONCLUSION

It will be understood that many additional changes in the details, materials, steps and arrangement of parts, which have been herein described and illustrated to explain the nature of the subject matter, may be made by those skilled in the art within the principle and scope of the invention as expressed in the appended claims.

What is claimed is:

1. A method of providing compliance auditing and management comprising:
establishing a set of compliance criteria;
providing a sensor capable of monitoring at least one condition for compliance and capable of communicating with a mobile networked communication device;
pairing the sensor with the mobile networked communication device using a short range wireless communication link;
providing data from the sensor to the networked communication device in a format compatible with an operating system of the mobile networked communication device, using filename conventions and other data characteristics are in a format compatible with network communication;
transmitting the data, comprising the monitored condition, from the sensor to a monitoring server, such that the transmitted data comprising the monitored condition, such that the monitoring server can derive a time profile of the monitored condition;
monitoring at least one condition identified by the compliance criteria; and
monitoring process to be monitored over time and monitored as a time-condition series.

2. The method of claim 1, further comprising real-time communications.

3. The method of claim 1, further comprising on demand auditing and compliance management.

4. The method of claim 1, further comprising:
defining business or enterprise assets, comprising receiving, from the business or enterprise variables that meet business needs of the business or enterprise as a user;
adding users, locations and audit templates;
entering questions to be provided to the user;
adding compliance criteria used in answering the questions and associating the compliance criteria with the questions;
receiving compliance activity information from the user;
applying the compliance activity information from the user to the questions;
scheduling compliance activity for the user to generate a database of deployed compliance activities;
using the database of deployed compliance activities to conduct compliance activity;
using the database of deployed compliance activities or the conducted compliance activity to generate files and incidents; and
using the database of deployed compliance activities to generate compliance activity reporting.

5. The method of claim 4, further comprising:
scheduling the compliance activity by assigning and deploy the compliance activity immediately to be given or scheduling the compliance activity for a pre-determined time and place;
notifying the user of the deployed or scheduled compliance, thereby permitting the user to review questions, scoring and criteria associated with the compliance activities; and
receiving requests for modifications for supervisory determination of the requests for modifications.

6. The method of claim 4, further comprising:
allowing a compliance agent to initiate an “incident” associated with a specific question or the activity, thereby allowing for predetermined procedure of escalation by the user.

7. A method of providing compliance auditing and management comprising:
identifying a set of enterprise assets for monitoring;
identifying compliance activity for monitoring the identified assets;
establishing a set of compliance criteria for monitoring the identified assets in accordance with needs of the enterprise and identified standards;
assign and deploy the compliance activity for performance immediately or scheduled for a pre-determined time and place;
presenting the compliance activity for review by an operator;
customizing monitoring the identified assets in accordance with at least one of the review by the operator and information obtained from previous audits;
associating a score value to the compliance activity;
scheduling deployment of the monitoring;
providing a sensor capable of monitoring at least one condition for compliance and capable of communicating with a mobile networked communication device;
pairing the sensor with the mobile networked communication device using a short range wireless communication link;
providing data from the sensor to the networked communication device in a format compatible with an operating system of the mobile networked communication device, using filename conventions and other data characteristics are in a format compatible with network communication;
transmitting the data, comprising the monitored condition, from the sensor to a monitoring server, such that transmitted data monitored condition, such that the monitoring server can derive a time profile of the monitored condition;
monitoring at least one condition identified by the compliance criteria;
monitoring process to be monitored over time and monitored as a time-condition series;
providing at least one of generated files, comments, incident reports and deployed compliance activities in response to the monitored condition;
storing the generated files, comments, incident reports and deployed compliance activities in a file; and
providing an alert or notification based on the monitored condition.

8. The method of claim 7, further comprising:
defining business or enterprise assets, comprising receiving, from the business or enterprise variables that meet business needs of the business or enterprise as a user;
adding users, locations and audit templates;
entering questions to be provided to the user;
adding compliance criteria used in answering the questions and associating the compliance criteria with the questions;
receiving compliance activity information from the user;
applying the compliance activity information from the user to the questions;
scheduling compliance activity for the user to generate a database of deployed compliance activities;
using the database of deployed compliance activities to conduct compliance activity;
using the database of deployed compliance activities or the conducted compliance activity to generate files and incidents; and
using the database of deployed compliance activities to generate compliance activity reporting.

9. The method of claim 8, further comprising:
scheduling the compliance activity by assigning and deploy the compliance activity immediately to be given or scheduling the compliance activity for a pre-determined time and place;
notifying the user of the deployed or scheduled compliance, thereby permitting the user to review questions, scoring and criteria associated with the compliance activities; and
receiving requests for modifications for supervisory determination of the requests for modifications.

10. The method of claim 8, further comprising:
allowing a compliance agent to initiate an “incident” associated with a specific question or the activity, thereby allowing for predetermined procedure of escalation by the user.
